(19) United States
(12) Patent Application Publication
(10) Pub. No.: US 2022/0289914 A1
(43) Pub. Date: Sep. 15, 2022

(54) METHOD FOR PRODUCING AQUEOUS CLEAR COATING COMPOSITION COMPRISING AQUEOUS SILICONE RESIN EMULSION

(71) Applicant: NIPPON PAINT INDUSTRIAL COATINGS CO., LTD., Tokyo (JP)

(72) Inventors: Taishi Higaki, Osaka (JP); Hiroki Ando, Osaka (JP); Yasumasa Nishiwaki, Osaka (JP); Masahiko Harada, Osaka (JP); Takehiro Ojima, Osaka (JP)

(73) Assignee: NIPPON PAINT INDUSTRIAL COATINGS CO., LTD., Tokyo (JP)

(21) Appl. No.: 17/685,728

(22) Filed: Mar. 3, 2022

(30) Foreign Application Priority Data
Mar. 9, 2021 (JP) 2021-037451

(51) Int. Cl. C08J 3/07; C09D 183/04; C08K 3/22; C08K 5/01; C08K 5/05; C08K 5/06; C09D 7/20

(52) U.S. Cl. CPC C08J 3/07; C09D 183/04; C08K 3/22; C08K 5/01; C08K 5/05; C08K 5/06; C09D 7/20; C08K 2003/2296; C08K 2003/2237; C08K 2201/003; C08K 2201/011; C08J 2383/04

(57) ABSTRACT

Provided is a method for producing an aqueous clear coating composition that is capable of providing an aqueous clear coating composition comprising inorganic oxide fine particles as an ultraviolet absorber and an aqueous silicone resin emulsion having good storage stability, which aqueous clear coating composition is capable of forming a coating film being superior in weatherability and durability (especially acid resistance) and high in transparency. A method for producing an aqueous clear coating composition comprising an aqueous silicone resin emulsion, the method comprising the following steps:
obtaining a silicone resin-organic solvent mixture from a mixture of a silicone resin (A) with an organic solvent (B1) by replacing at least portion of the organic solvent (B1) with an organic solvent (B2) and/or an organic solvent (B3),
mixing the silicone resin-organic solvent mixture, the organic solvent (B2) and/or the organic solvent (B3), and inorganic oxide fine particles (D) to obtain a silicone resin mixture, and
subjecting the silicone resin mixture and a mixture of an emulsifier (C) with an aqueous medium to a mechanical emulsification treatment, or subjecting a mixture of the silicone resin mixture with an emulsifier (C) and an aqueous medium to a mechanical emulsification treatment to obtain an aqueous silicone resin emulsion,
wherein the silicone resin (A) comprises a branched organopolysiloxane (A1) having a weight average molecular weight of 5,000 to 300,000,
wherein the organic solvent (B1) comprises a hydrocarbon-based solvent having a solubility of 1 g/100 g-H₂O or less in water,
wherein the organic solvent (B2) comprises at least one solvent selected from a group consisting of an alcohol, an alkylene glycol monoalkyl ether, and an alkylene glycol dialkyl ether, and the organic solvent (B2) has a solubility of less than 5 g/100 g-H₂O in water,
wherein the organic solvent (B3) is at least one solvent selected from a group consisting of an alcohol, an alkylene glycol monoalkyl ether, and an alkylene glycol dialkyl ether, and the organic solvent (B3) has a solubility of 5 g/100 g-H₂O or more in water, and
wherein the silicone resin mixture comprises both the organic solvent (B2) and the organic solvent (B3).

### BACKGROUND OF THE INVENTION

The present disclosure relates to a method for producing an aqueous clear coating composition comprising an aqueous silicone resin emulsion.

Various coating compositions for exterior coating are applied onto walls of buildings including houses and high-rise buildings for the purpose of maintaining the quality and appearance of wall surfaces under exposure to wind, rain, and direct sunlight. Such a coating composition is desired to have weatherability against wind or rain, water resistance, light resistance, color fastness, and adhesiveness to substrates. Further, in the field of coatings, aqueous coating compositions has been more adopted in recent years from the viewpoints of environmental burden, safety in painting work and sanitation. As an aqueous coating composition for exterior coatings, coating compositions containing an acrylic resin emulsion are widely used.

In the case where long-term weatherability and durability are required, such coating compositions are used that contain an acrylic silicone resin emulsion, which is silicone-modified with a modifier having a specific silicone structure. In recent years, further improvement in performance has been desired, and a need is rising for an aqueous coating composition that exhibits superior weatherability and durability, which can maintain its appearance for a long period even under, especially, severe outdoor environments. Furthermore, for example, an aqueous clear coating composition is desired to have the above-mentioned weatherability and durability, and it is also desired to provide a coating film with high transparency, that is, transparency in the visible light range.

For example, JP-A-2001-172340 (Patent Literature 1) describes a resin composition comprising a polyalkoxypolysiloxane-based compound (A) obtained by reacting a polyalkoxypolysiloxane (a1) with a polymer compound (a2) having a functional group capable of reacting with the siloxane, a polymer (B′) of a radically polymerizable unsaturated monomer (B), and a silicate oligomer (C). JP-A-2001-172340 describes that an aqueous resin composition as described above exhibits superior effects on the standing stability of the resin composition and on the weatherability, stain resistance, water resistance, solvent resistance, crack resistance of a coating film.

JP-A-2014-031413 (Patent Literature 2) describes a method for producing a silicone resin emulsion containing no organic solvents, and the method is characterized by (i) replacing a solvent component of an organic solvent solution of a silicone resin (A) synthesized in an organic solvent with a nonionic emulsifier (B), thereby forming a nonionic emulsifier solution of the silicone resin (A); (ii) adding water to the nonionic emulsifier solution of the silicone resin (A); and (iii) emulsifying. JP-A-2014-031413 describes an acquisition of a silicone resin emulsion free of organic solvent and superior in stability.

JP-A-2003-213005 (Patent Literature 3) describes a method for producing an organopolysiloxane emulsion in which a dispersion containing an organopolysiloxane, a surfactant and water as main components is separated into at least two channels and then the two portions of the dispersion are jet-impinged to be micronized, and it specified that the flow rate at the time of jet-impingement was 400 m/s or more. JP-A-2003-213005 describes that an organopolysiloxane emulsion can be obtained with small average particle diameter and various types of stability such as storage stability, dilution stability, and mechanical stability.

Meanwhile, organic ultraviolet absorbers (for example, benzotriazole-based ultraviolet absorbers and triazine-based ultraviolet absorbers) are commonly added to a clear coating composition for the purpose of weatherability improvement. An organic ultraviolet absorber is capable of imparting ultraviolet blocking property to a coating film while maintaining the visible light transparency, which is required in a clear coating composition.

### SUMMARY OF THE INVENTION

In order to further improve the weatherability of emulsions as those described in JP-A-2001-172340, JP-A-2014-031413 or JP-A-2003-213005, such coating compositions has been studied that is an emulsion containing an organic ultraviolet absorber, for example a benzotriazole-based ultraviolet absorber.

However, on usage of an organic ultraviolet absorber, that ultraviolet absorber is found to elute from a coating film by a long-term outdoor exposure, and ultraviolet blocking property of the coating film can not be maintained for a long period of time resulting in a difficulty to exhibit expected weatherability.

For example, in JP-A-2013-159668 (Patent Literature 4), a coating composition has been studied in which an inorganic ultraviolet absorber that is hardly elutable from a coating film is added. However, on usage of an inorganic ultraviolet absorber, there was a problem found that the formed coating film exhibits insufficient properties in the storage stability of the resulting coating composition or the durability, especially acid resistance and weatherability.

The present disclosure is directed to solve the problems described above. Specifically, the present disclosure is directed to provide a method for producing an aqueous clear coating composition comprising inorganic oxide fine particles as an ultraviolet absorber, and an aqueous silicone resin emulsion having good storage stability. The aqueous clear coating composition is capable of forming a coating film with superior weatherability and durability (especially acid resistance) and high transparency.

The present disclosure provides the following.

A method for producing an aqueous clear coating composition comprising an aqueous silicone resin emulsion, the method comprising:

obtaining a silicone resin-organic solvent mixture from a mixture of a silicone resin (A) with an organic solvent (B1) by replacing at least portion of the organic solvent (B1) with an organic solvent (B2) and/or an organic solvent (B3);

mixing the silicone resin-organic solvent mixture, the organic solvent (B2) and/or the organic solvent (B3), and inorganic oxide fine particles (D) to obtain a silicone resin mixture; and

subjecting the silicone resin mixture and a mixture of an emulsifier (C) with an aqueous medium to a mechanical emulsification treatment, or subjecting a mixture of the silicone resin mixture with an emulsifier (C) and an aqueous medium to a mechanical emulsification treatment to obtain an aqueous silicone resin emulsion,

wherein the silicone resin (A) comprises a branched organopolysiloxane (A1) having a weight average molecular weight of 5,000 to 300,000,

wherein the organic solvent (B1) is a hydrocarbon-based solvent having a solubility in water of 1 g/100 g-H₂O or less,
wherein the organic solvent (B2) comprises at least one solvent selected from the group consisting of an alcohol, an alkylene glycol monoalkyl ether, and an alkylene glycol dialkyl ether, and the organic solvent (B2) has a solubility of less than 5 g/100 g-H₂O in water,
wherein the organic solvent (B3) comprises at least one solvent selected from the group consisting of an alcohol, an alkylene glycol monoalkyl ether, and an alkylene glycol dialkyl ether, and the organic solvent (B3) has a solubility of 5 g/100 g-H₂O or more in water, and
wherein the silicone resin mixture comprises both the organic solvent (B2) and the organic solvent (B3).

The present disclosure provides a method for producing an aqueous clear coating composition comprising inorganic oxide fine particles as an inorganic ultraviolet absorber, and an aqueous silicone resin emulsion having good storage stability. The aqueous clear coating composition is capable of forming a coating film being superior in weatherability and durability (especially acid resistance) and high in transparency.

### DETAILED DESCRIPTION OF THE PREFERRED EMBODIMENTS

When inorganic oxide fine particles are post-added to the aqueous silicone resin emulsion and mixed with a disper, storage stability and durability of the resulting coating composition were insufficient, especially acid resistance and weatherability.

In addition, when emulsifying with high shear force by means of a high-pressure homogenizer (hereinafter, this method is also referred to as a “high pressure emulsification method”) as in JP-A-2001-172340, usage of inorganic oxide fine particles sometimes resulted in an emulsion with insufficient storage stability because inorganic oxide fine particles were separated from a silicone resin because of its high specific gravity. Further, in an aqueous clear coating composition containing an emulsion formed by using a high pressure emulsification method, coating film were not good in physical properties, especially acid resistance in some cases.

The present inventors intensively studied on a method of appropriately mixing a silicone resin (A) with inorganic oxide fine particles (D), and found the following method of the present disclosure.

The present disclosure provides a method for producing an aqueous clear coating composition comprising an aqueous silicone resin emulsion, and the method includes the following steps:

an organic solvent replacement step of obtaining a silicone resin-organic solvent mixture from a mixture of a silicone resin (A) with an organic solvent (B1) by replacing at least portion of the organic solvent (B1) with an organic solvent (B2) and/or an organic solvent (B3);

a mixing step of mixing the silicone resin-organic solvent mixture with the organic solvent (B2) and/or the organic solvent (B3), and inorganic oxide fine particles (D) to obtain a silicone resin mixture; and

an emulsification step of subjecting the silicone resin mixture and a mixture of an emulsifier (C) with an aqueous medium to mechanical emulsification treatment, or subjecting a mixture of the silicone resin mixture with an emulsifier (C) and an aqueous medium to mechanical emulsification treatment to obtain an aqueous silicone resin emulsion. The silicone resin mixture comprises both the organic solvent (B2) and the organic solvent (B3).

The method of the present disclosure provides to produce an aqueous clear coating composition, which comprises an aqueous silicone resin emulsion having good storage stability, and which is capable of forming a coating film with superior weatherability and durability (especially acid resistance) and high transparency. Although it should not be construed as a limited or specified theory, at least portion of the inorganic oxide fine particles (D) is supposed to be included in the silicone resin (A) by virtue of using specific organic solvents (B2) and (B3) and going through the steps described above. As a result, the inorganic oxide fine particles (D) are supposed to be stably present in the aqueous silicone resin emulsion and further in the aqueous clear coating composition, and detachment of the inorganic oxide fine particles (D) can be suppressed in the coating film.

Further, the present disclosure results in a satisfactory emulsification of a silicone resin (A) comprising a branched organopolysiloxane (A1) with a sufficiently fine average particle diameter.

[Silicone Resin (A)]

The silicone resin (A) comprises a branched organopolysiloxane (A1) having a weight average molecular weight of 5,000 to 300,000. The weight average molecular weight of the branched organopolysiloxane (A1) is preferably 5,000 to 100,000, more preferably 5,000 to 80,000, and further preferably 5,000 to 50,000. These conditions of the weight average molecular weight of the branched organopolysiloxane (A1) provide a silicone resin emulsion having good storage stability can be prepared. Moreover, an aqueous clear coating composition prepared by using the silicone resin emulsion exhibits an advantage of affording a coating film with good coating film strength, and weatherability.

The branched organopolysiloxane (A1) comprises, for example, a compound having a structure represented by the following formula.

[R¹SiO_{3/2}]ₘ[R²₂SiO]ₙ

In the above formula, R¹ and R² each independently represents hydroxyl group or a monovalent organic group having 1 to 20 carbon atoms, which may have a substituent as necessary, m is 1 to 1,000, and n is 0 to 100.

In the above formula, m represents number of [R¹SiO_{3/2}] units, and n represents number of [R²₂SiO] units. Inclusion of [R¹SiO_{3/2}] units leads to a branched organopolysiloxane. In the above formula, m+n is preferably 1 to 1,000.

Specific examples of R¹ and R² in the above formula include alkyl groups having 1 to 20 carbon atoms such as methyl group, ethyl group, propyl group, butyl group, pentyl group, hexyl group, heptyl group, octyl, group, nonyl group, decyl group, dodecyl group, tetradecyl group, hexadecyl group, octadecyl group, cyclopentyl group, cyclohexyl group and cycloheptyl group; aryl groups having 6 to 20 carbon atoms such as phenyl group, tolyl group, xylyl group and naphthyl group; alkenyl groups having 2 to 20 carbon atoms such as vinyl group and allyl group; and hydroxyl group. These groups may have substituents if necessary. Examples of the substituents include polar group-containing substituents such as halogen atoms, amino group, acryloxyl group, methacryloxyl group, epoxy group, mercapto group, and carboxyl group.

In the above formula, each of R¹ and R² is preferably hydroxyl group, a linear hydrocarbon group having 1 to 6 carbon atoms, or an aromatic hydrocarbon group having 5 to 7 carbon atoms independently.

More preferably, the branched organopolysiloxane (A1) comprises a compound having a structure represented by the above formula, wherein R¹ and R² each independently represents hydroxyl group, a linear hydrocarbon group having 1 to 6 carbon atoms or an aromatic hydrocarbon group having 5 to 7 carbon atoms, m is 1 to 1,000, n is 1 to 100, and m+n is 1 to 1,000.

As to R¹ and R² in the above formula, it is more preferable that 30 mol % or more of them be methyl group, and even more preferable that 50 mol % or more of them be methyl group.

In the above formula, m:n is preferably in a range of 2:8 to 10:0, more preferably 3:7 to 10:0, and even more preferably 4:6 to 10:0. As to the above-mentioned ratio, a condition where the ratio of n is 8 or less is advantageous in that the hardness of a resulting coating film falls within a preferable range and good durability can be obtained.

The branched organopolysiloxane (A1) can be prepared, for example, by subjecting a silane compound such as a chlorosilane or an alkoxysilane to a hydrolysis and a condensation reaction.

As the branched organopolysiloxane (A1), a commercially available product may be used.

Examples of such a commercially available product include 804 RESIN, 805 RESIN, 840 RESIN and SR-2400 produced by Dow Corning Toray Silicone Co., Ltd., KR-220L, KR-242A, KR-251, KR-225, KR-271, KR-282 and X40-2406 produced by Shin-Etsu Chemical Co., Ltd.; SILRES K, SILRES KX, SILRES HK46, SILRES REN50, SILRES REN60, SILRES H62C and SILRES MES100 produced by Wacker Asahikasei Silicone Co., Ltd.

The silicone resin (A) preferably comprises a linear organopolysiloxane (A2) having a weight average molecular weight of 1,000 to 30,000 in addition to the branched organopolysiloxane (A1).

The inclusion of such a silicone resin (A) further improves the water resistance, chemical resistance in a coating film formed from the aqueous clear coating composition. This is supposed to be because of the inclusion of the linear organopolysiloxane (A2) together with the branched organopolysiloxane (A1). These supposed to improve the curing reactivity during coating film formation. Further, a cross-linked structure or a structure similar to a cross-linked structure is supposed to form in the silicone resin (A) due to the inclusion of the linear organopolysiloxane (A2), and it is supposed to contribute to an improvement in water resistance and chemical resistance.

Examples of the linear organopolysiloxane (A2) include compounds having a structure represented by the following formula.

R³—[R⁴₂SiO]ₓ—R⁵

In the above formula, R³ is hydroxyl group, a linear hydrocarbon group having 1 to 6 carbon atoms or an aromatic hydrocarbon group having 5 to 7 carbon atoms, R⁴ is a linear hydrocarbon group having 1 to 6 carbon atoms or an aromatic hydrocarbon group having 5 to 7 carbon atoms, R⁵ is hydrogen, a linear hydrocarbon group having 1 to 6 carbon atoms or an aromatic hydrocarbon group having 5 to 7 carbon atoms, and x is 1 to 400.

The solid mass ratio of the branched organopolysiloxane (A1) and the linear organopolysiloxane (A2) in the aqueous clear coating composition is preferably in a range of (A1):(A2)=98:2 to 40:60, more preferably 98:2 to 50:50, and may be, for example, 98:2 to 70:30. When the solid mass ratio is in the above range, the water resistance and chemical resistance of a resulting coating film are further improved.

[Organic Solvent (B)]

The organic solvent (B) comprises organic solvents (B1), (B2), and (B3).

In the aqueous clear coating composition, the mass ratio (A):(B) of the silicone resin (A) to the organic solvent (B) is preferably in a range of 1:2 to 1:0.1, more preferably 1:1 to 1:0.2, and even more preferably 1:0.8 to 1:0.3. Inclusion of the organic solvent (B) in the above ratio readily adjust the viscosity of the aqueous clear coating composition and allows the aqueous clear coating composition to be stably present.

(Organic Solvent (B1))

The organic solvent (B1) is provided as a mixture with the silicone resin (A). The organic solvent (B1) comprises a hydrocarbon-based solvent having a solubility of 1 g/100 g-H₂O or less in water. In the present specification, the term “hydrocarbon-based” refers to a compound composed only of carbon atoms and hydrogen atoms, and the term “solubility in water” means solubility at 20° C.

The solubility of the organic solvent (B1) in water may be, for example, 0.01 g/100 g-H₂O or more.

Preferably, the organic solvent (B1) mixes with the silicone resin (A) at an arbitrary ratio. Here, the term “to mix” means to mix at 20° C.

The organic solvent (B1) may be a single kind of hydrocarbon-based solvent having a solubility of 1 g/100 g-H₂O or less, or may be a mixture of such hydrocarbon-based solvents.

The organic solvent (B1) comprises preferably at least one selected from an aromatic hydrocarbon-based solvent having 6 to 20 carbon atoms and an aliphatic hydrocarbon-based solvent having 6 to 20 carbon atoms, more preferably at least one selected from an aromatic hydrocarbon-based solvent having 6 to 10 carbon atoms and an aliphatic hydrocarbon-based solvent having 6 to 10 carbon atoms, and even more preferably an aromatic hydrocarbon-based solvent having 6 to 8 carbon atoms.

Specific examples of the organic solvent (B1) include a hydrocarbon-based solvent having 6 to 8 carbon atoms, specifically, a hydrocarbon-based solvent such as benzene, toluene, xylene, hexane, and cyclohexane.

In one embodiment, the organic solvent (B1) comprises an organic solvent having lower boiling point than the organic solvent (B2) and the organic solvent (B3).

The boiling point of the organic solvent (B1) may be 65 to 140° C.

The organic solvent (B1) may be 0 to 15 parts by mass or may be 0 to 10 parts by mass, based on 100 parts by mass of the aqueous clear coating composition.

The organic solvent (B1) may be 1 to 15 parts by mass or may be 2 to 10 parts by mass, based on 100 parts by mass of the aqueous clear coating composition.

In one embodiment, the aqueous clear coating composition is substantially free of the organic solvent (B1). Here, “substantially free of” means not contained at all or may be contained in an extremely small amount. For example, the content of the organic solvent (B1) may be 1 part by mass or less, may be 0.5 parts by mass or less, or may be less than 0.1 parts by mass, based on 100 parts by mass of the aqueous clear coating composition.

(Organic Solvent (B2))

The organic solvent (B2) is at least one solvent selected from a group consisting of an alcohol, an alkylene glycol monoalkyl ether, and an alkylene glycol dialkyl ether, and the solubility of the organic solvent (B2) is less than 5 g/100 g-H₂O in water. The usage of the organic solvent (B2) can reduce the viscosity in the organic solvent replacement step, in the mixing step, and/or in addition, in the emulsification step, and thus the operation can be facilitated.

The solubility of the organic solvent (B2) exhibits, for example, is more than 0.1 g/100 g-H₂O in water.

The usage of the organic solvent (B2) can adjust the viscosity of the resin emulsion in the emulsification treatment in the emulsification step, and thus stable emulsion fine particles can be obtained.

The organic solvent (B2) comprises preferably an alkylene glycol dialkyl ether.

In one embodiment, examples of the organic solvent (B2) include an organic solvent having 6 to 16 carbon atoms.

As the organic solvent (B2), examples of the alcohol include a monohydric alcohol having a hydrocarbon group having 6 to 12 carbon atoms, preferably 6 to 8 carbon atoms, and one hydroxyl group. The hydrocarbon group may have a structure having a ring structure or may have a linear or branched structure having no ring structure.

In one embodiment, as the alkylene glycol monoalkyl ether, a compound represented by the following formula can be used.

C_{b}H_{2b+1}O(CₐH₂ₐO)_{a′}H

Here, a is an integer of 1 to 4, preferably an integer of 1 to 3; a′ is an integer of 1 to 2, preferably an integer of 1 to 2; and b is an integer of 4 to 10, preferably an integer of 4 to 8.

In one embodiment, as the alkylene glycol dialkyl ether, a compound represented by the following formula can be used.

C_{d}H_{2d+1}O(C_{c}H_{2c}O)_{c′}C_{d}H_{2d+1}

Here, c is an integer of 1 to 4, preferably an integer of 1 to 3; c′ is an integer of 1 to 3, preferably an integer of 1 to 3; and d is independently at each occurrence an integer of 3 to 6. For example, a compound in which c is 2, c′ is 1 or 2, and d is 4 can be used.

Examples of the organic solvent (B2) include alcohols such as hexanol, cyclohexanol, and octanol; alkylene glycol monoalkyl ethers such as ethylhexyl glycol, ethylene glycol phenyl ether, and propylene glycol phenyl ether; and alkylene glycol dialkyl ethers such as ethylene glycol dibutyl ether and diethylene glycol dibutyl ether. These may be used singly, or two or more of them may be used in combination.

The boiling point of the organic solvent (B2) may be 150 to 260° C.

The organic solvent (B2) may be 1 to 20 parts by mass or may be 1 to 15 parts by mass, based on 100 parts by mass of the aqueous clear coating composition. Containing the organic solvent (B2) in the above range can readily adjust the viscosity in the emulsification step.

(Organic Solvent (B3))

The organic solvent (B3) is at least one solvent selected from a group consisting of an alcohol, an alkylene glycol monoalkyl ether, and an alkylene glycol dialkyl ether, and the solubility of the organic solvent (B3) is 5 g/100 g-H₂O or more in water. The usage of the organic solvent (B3) can reduce the viscosity in the organic solvent replacement step and/or the mixing step thereby facilitating the operation. In addition, in the emulsification step, emulsification can be performed more stably.

In one embodiment, the solubility of the organic solvent (B3) is 20 g/100 g-H₂O or less in water.

In one embodiment, the organic solvent (B3) may be mixed with water in any ratio.

The organic solvent (B3) is preferably an alkylene glycol monoalkyl ether.

In one embodiment, examples of the organic solvent (B3) include an organic solvent having 4 to 8 carbon atoms.

As to the organic solvent (B3), examples of the alcohol include a monohydric alcohol having a hydrocarbon group having 4 to 5 carbon atoms and one hydroxyl group, a dihydric alcohol having a hydrocarbon group having 2 to 3 carbon atoms and two hydroxyl groups (that is, alkylene glycol), and a trihydric alcohol having a hydrocarbon group having 3 to 4 carbon atoms and three hydroxyl groups (that is, alkylene triol).

In one embodiment, as the alkylene glycol monoalkyl ether, a compound represented by the following formula can be used.

C_{f}H_{2f+1}O(CₑH₂ₑO)_{e′}H

Here, e is an integer of 1 to 4, preferably an integer of 1 to 3; e′ is an integer of 1 to 2, preferably an integer of 1 to 2; and f is an integer of 1 to 5, preferably an integer of 1 to 4. For example, a compound in which e is 3, e′ is 1, and f is 4 can be used.

In one embodiment, as the alkylene glycol dialkyl ether, a compound represented by the following formula can be used.

CₕH₂ₕ₊₁O(C_{g}H_{2g}O)_{g′}CₕH₂ₕ₊₁

Here, g is an integer of 1 to 3, preferably an integer of 1 to 2; g′ is an integer of 1 to 2, preferably an integer of 1 to 2; and h is independently at each occurrence an integer of 1 to 3, preferably independently at each occurrence an integer of 1 to 2. For example, a compound in which g is 2, g′ is 1, and h is 1 can be used.

Examples of the organic solvent (B3) include alcohols such as ethylene glycol, propylene glycol, and glycerin; alkylene glycol monoalkyl ethers such as ethylene glycol monomethyl ether, ethylene glycol monoethyl ether, ethylene glycol monopropyl ether, ethylene glycol monobutyl ether, propylene glycol monomethyl ether, propylene glycol monoethyl ether, propylene glycol monopropyl ether, and propylene glycol monobutyl ether; and alkylene glycol dialkyl ethers such as ethylene glycol dimethyl ether, ethylene glycol diethyl ether, diethylene glycol dimethyl ether, diethylene glycol diethyl ether, propylene glycol dimethyl ether, and dipropylene glycol dimethyl ether. These may be used singly, or two or more of them may be used in combination.

The boiling point of the organic solvent (B3) may be 120 to 200° C.

The organic solvent (B3) may be 1 to 20 parts by mass or may be 1 to 15 parts by mass, based on 100 parts by mass of the aqueous clear coating composition. By containing the organic solvent (B3) in the above range, emulsification can be performed more easily in the emulsification step.

The total amount of the organic solvent (B2) and the organic solvent (B3) may 1 to 30 parts by mass or may be 1 to 20 parts by mass, based on 100 parts by mass of the aqueous clear coating composition.

The inclusion of the organic solvent (B2) and the organic solvent (B3) can suppress aggregation in the silicone resin mixture. In addition, the inclusion of the organic solvent (B2) and the organic solvent (B3) can increase the viscosity of the silicone resin mixture thereby facilitating emulsification in the emulsification. Furthermore, the resulting aqueous silicone resin emulsion can be stably present.

In the aqueous clear coating composition, a mass ratio (B2):(B3) of the organic solvent (B2) to the organic solvent (B3) may be 1:0.2 to 1:2, or may be 1:0.2 to 1:1. By containing these in such a mass ratio, emulsification in the emulsification step can be performed more easily. In addition, the resulting aqueous silicone resin emulsion can be more stably present.

[Emulsifier (C)]

By adding the emulsifier (C), the aqueous silicone resin emulsion can be stably emulsified.

The emulsifier (C) is not particularly limited as long as it can stably emulsify the aqueous silicone resin emulsion. For example,

anionic surfactants such as alkyl sulfates, polyoxyethylene alkyl ether sulfates, polyoxyalkylene alkenyl ether sulfates, alkyl diphenyl ether sulfates, polyoxyethylene alkyl ether acetates, alkylbenzene sulfonates, and alkenyl succinates;

cationic surfactants such as quaternary ammonium salts;

nonionic surfactants such as glycerol fatty acid esters, propylene glycol fatty acid esters, sorbitan fatty acid esters, polyoxyethylene sorbitan fatty acid esters, polyoxyethylene sorbitol fatty acid esters, polyoxyethylene alkyl ethers, polyoxyalkylene alkyl ethers, polyoxyethylene polyoxypropylene glycols, polyoxyethylene hardened castor oil, polyethylene glycol fatty acid esters, alkyl glyceryl ethers, alkyl alkanol amides, and alkyl polyglucosides;

amphoteric surfactants such as alkyl betaines, imidazoline type betaines, alkylamine oxides, alkylamidopropyl betaines, and alkylhydroxysulfobetaines can be used.

These emulsifiers (C) may be used singly, or two or more of them may be used in combination.

The emulsifier (C) preferably comprises an anionic surfactant. When an emulsifier (C) comprising an anionic surfactant is used, a silicone resin emulsion can be obtained with a suitable average particle diameter and superior storage stability.

Examples of preferable anionic surfactants include Newcol 707SN, Newcol 714SN, Newcol 780SF, Newcol 2308SF (all produced by Nippon Nyukazai Co., Ltd.), which are polyoxyethylene alkyl ether sulfates; LATEMUL PD-104 (produced by Kao Corporation) and Aqualon KH-1025 (produced by DKS Co. Ltd.), which are polyoxyalkylene alkenyl ether sulfates; NEOGEN S-20F (produced by DKS Co. Ltd.), NEOPELEX G-65 and NEOPELEX G-25 (both produced by Kao Corporation), which are alkyl benzene sulfonates; PELEX SS-L and PELEX SS-H (both produced by Kao Corporation), which are alkyl diphenyl ether sulfates; and LATEMUL ASK and LATEMUL DSK (both produced by Kao Corporation), which are alkenyl succinates.

In one embodiment, the emulsifier (C) comprises an anionic surfactant and a nonionic surfactant.

[Inorganic Oxide Fine Particles (D)]

The inclusion of the inorganic oxide fine particles (D) in the aqueous clear coating composition can maintain the weatherability for a long period of time while maintaining the visible light transparency in a resulting coating film, which are desired properties for a clear coating composition.

Examples of the inorganic oxide of the inorganic oxide fine particles (D) include silicon oxide, titanium oxide, zinc oxide, tin oxide, cerium oxide, antimony oxide, and their mixed oxides. The inorganic oxide fine particles (D) preferably comprise at least one selected from a group consisting of titanium oxide, zinc oxide and cerium oxide, and more preferably comprise at least one selected from a group consisting of titanium oxide and zinc oxide. The inclusion of such inorganic oxides further improves the ultraviolet absorbing performance and the visible light transparency in a coating film. Such inorganic oxide fine particles (D) can contribute to the improvement of a storage stability of the aqueous clear coating composition.

In one embodiment, the inorganic oxide fine particles (D) are preferably at least one selected from a group consisting of titanium oxide, zinc oxide and cerium oxide, and more preferably at least one selected from a group consisting of titanium oxide and zinc oxide.

In the aqueous clear coating composition, the content of the inorganic oxide fine particles (D) is preferably 3 to 20 parts by mass, and more preferably 2 to 15 parts by mass based on 100 parts by mass of the solid content of the silicone resin (A). The amount of the inorganic oxide fine particles (D) in the above range contributes to form a coating film having good weatherability while maintaining the required visible light transparency, which is a desired property for a clear coating composition.

The inorganic oxide fine particles (D) may be surface-treated on their surface. That is, the inorganic oxide fine particles (D) may comprise a surface coating layer on the surface thereof.

The inorganic oxide fine particles (D) may be, for example, those with an organic surface coating of an organosilicon, those with an inorganic surface coating of a hydroxide and/or an oxide of one or more elements selected from silicon, aluminum, zinc, iron, titanium and zirconium, or those with both the inorganic and the organic surface coatings.

Examples of the surface-treatment for forming the organic surface coating include a treatment using an organosilicon compound such as a silicone compound having a hydrogen-silicon bond, for example, methyl hydrogen polysiloxane copolymer or a compound having an alkoxy group-silicon bond as a reactive group (for example, triethoxysilylethyl polydimethylsiloxyethyl dimethicone and triethoxysilylethyl polydimethylsiloxyethyl hexyl dimethicone).

The organic surface coating treatment method is not particularly limited, and a known method such as dry treatment or wet treatment may be used.

Preferably, the organic surface coating treatment is preferably performed in an amount of 0.1 to 20 mass % based on the mass of the inorganic oxide fine particles (D) after the coating treatment.

Examples of the surface treatment for forming the inorganic surface coating include treatments using a surface treatment agent that provides inorganic surface coating comprising a hydroxide and/or an oxide of one or more elements selected from silicon, aluminum, zinc, iron, titanium and zirconium. Examples of such a surface treatment agent include surface treatment agents comprising sodium silicate, tetramethyl silicate and a condensate thereof, tetraethyl silicate and a condensate thereof, sodium aluminate, sodium zirconate, aluminum sulfate, aluminum nitrate, aluminum chloride, as well as sulfates, nitrates and chlorides of the above elements.

The inorganic surface coating treatment method using the surface treatment agent is not particularly limited, and examples thereof include: a method in which inorganic oxide fine particles are dispersed in water to form a water slurry and a surface treatment agent is added to the water slurry, followed by conductions of drying, calcination and pulverization; a method in which inorganic oxide fine particles are dispersed in water to form a water slurry, and a surface treatment agent is added to the water slurry, followed by conductions of a neutralization, washing with water, drying and pulverization; a method in which a surface treatment agent is added to inorganic oxide fine particles, followed by a calcination, thereby thermally decomposing the surface treatment agent.

Preferably, the amount of the inorganic surface coating is 0.1 to 30 mass % based on the mass of the inorganic oxide fine particles (D) after the coating treatment.

More preferably, the surface treatment is conducted in such an embodiment where inorganic surface coating treatment is performed as a first surface treatment to form an inorganic surface coating layer, and subsequently organic surface coating treatment is performed as a second surface treatment to form an organic surface coating layer. More preferable embodiments include an embodiment where an inorganic surface coating layer is formed using hydrous silica as the first surface treatment, and subsequently an organic surface coating layer is formed using an organopolysiloxane as the second surface treatment. Examples of inorganic oxide fine particles (D) subjected to such surface treatment include FINEX Series produced by Sakai Chemical Industry Co., Ltd.

Examples of inorganic oxide fine particles (D) of silicon oxide include silica fine particles having an average particle diameter in the above range. Specific examples of such silica fine particles include methanol silica sol, IPA-ST, IPA-ST-ZL, EG-ST, NPC-ST-30, DMAC-ST, MEK-ST, MIBK-ST, XBA-ST, PMA-ST and PGM-ST, which are organosilica sols produced by Nissan Chemical Corporation.

Examples of inorganic oxide fine particles (D) of titanium oxide include 1120Z, 2120Z, 6320Z produced by JGC Catalysts and Chemicals Ltd., TECNADIS-TI 220 produced by TECNAN, STR Series produced by Sakai Chemical Industry Co., Ltd., and TTO Series produced by Ishihara Sangyo Kaisha, Ltd.

Examples of inorganic oxide fine particles (D) of tin oxide include CX-S303IP, CX-S301H, CX-S501M and CX-S505M produced by Nissan Chemical Corporation.

Examples of inorganic oxide fine particles (D) of cerium oxide include CE-20A produced by Nissan Chemical Corporation and TECNADIS-CE-220 produced by TECNAN.

Examples of inorganic oxide fine particles (D) of zinc oxide include F-2, F-1 produced by Hakusuitech Co., Ltd., ZnO-310, ZnO-410, ZnO-510 produced by Sumitomo Osaka Cement Co., Ltd., TECNADIS-ZN-220 produced by TECNAN, FINEX Series produced by Sakai Chemical Industry Co., Ltd., and FZO Series produced by Ishihara Sangyo Kaisha, Ltd.

Examples of inorganic oxide fine particles (D) of antimony oxide include PATOX-U produced by Nihon Seiko Co., Ltd.

Examples of inorganic oxide fine particles (D) of a mixed oxide of metal oxides include a mixed oxide (ZnSb₂O₆) of zinc oxide (ZnO) and antimony pentoxide (Sb₂O₅). Specific examples of such mixed oxides include CX-Z210IP-F2, CX-Z330H and CX-Z610M-F2 produced by Nissan Chemical Corporation.

The average particle diameter of the inorganic oxide fine particles (D) is preferably 20 to 300 nm, and more preferably 20 to 100 nm. By using the inorganic oxide fine particles (D) described above, ultraviolet blocking performance is imparted while maintaining the visible light transparency in a coating film, and ultraviolet blocking property is maintained for a long period of time.

In the present specification, the average particle diameter of the inorganic oxide fine particles (D) means 50% volume particle diameter (D50, also referred to as volume-based cumulative particle diameter D50). Specifically, when expressing a cumulative volume of particles integrated from smallest particle diameter to a certain particle diameter in a particle size distribution of the inorganic oxide fine particles (D) as a percentage based on the total volume of all particles, a particle diameter at a percentage of 50% is defined as the average particle diameter. The 50% volume particle diameter (D50) can be measured using a laser diffraction/scattering method, for example, using UPA-150 (particle size distribution analyzer manufactured by MicrotracBEL Corp.).

The inorganic oxide fine particles (D) having an average particle diameter as described above are obtained by performing wet dispersion treatment. The wet dispersion treatment can be conducted by stirring the inorganic oxide fine particles (D) in a liquid comprising an organic solvent to disperse the particles finely.

The wet dispersion treatment of the inorganic oxide fine particles (D) can be performed by common disper dispersion, mill dispersion, or the like. In the wet dispersion treatment, a dispersant may be used, as necessary.

The viscosity at the time of wet dispersion is preferably 300 mPa·s or less, and more preferably 100 mPa·s or less.

As the dispersant, a polymer dispersant, which is used in the field of coating material, can be preferably used.

Examples of the polymer dispersant include dispersants having a polyester-based, polyacrylic-based, polyurethane-based, polyamine-based, or polycaprolactone-based main chain and having polar groups such as amino group, carboxy group, sulfo group and hydroxy group on side chains.

Specific examples of the polymer dispersant include:

(co)polymers of unsaturated carboxylic acid esters, such as polyacrylic acid esters;

copolymers of an aromatic vinyl compound, such as styrene and α-methylstyrene, and an unsaturated carboxylic acid ester, such as an acrylic acid ester;

(partial) amine salts, (partial) ammonium salts or (partial) alkylamine salts of unsaturated carboxylic acid (co)polymers, such as polyacrylic acid;

hydroxyl group-containing unsaturated carboxylic acid ester (co)polymers, such as hydroxyl group-containing polyacrylic acid ester, or modified products thereof;

polyurethanes; unsaturated polyamides; polysiloxanes; long chain polyaminoamide phosphate salts; polyethyleneimine derivatives (amides obtained by reaction of poly(lower alkylene imine) with free carboxyl group-containing polyester, or bases thereof);

polyallylamine derivatives (reaction products obtained by reacting polyallylamine with one or more compounds selected from three compounds, namely, a polyester having free carboxyl group, a polyamide, and a co-condensate of ester and amide (that is, a polyester amide)).

As the polymer dispersant, a commercially available product may be used. Examples of such commercially available products include DISPERBYK Series (produced by BYK Chemie), Solsperse Series (produced by The Lubrizol Corporation), EFKAPOLYMER Series (produced by BASF), and SN-DISPERSANT Series (produced by San Nopco Ltd.).

Examples of the organic solvent contained in the liquid comprising the organic solvent include alcohol solvents such as methanol, ethanol, propanol, and butanol; ketone solvents such as methyl ethyl ketone, acetone, methyl isobutyl ketone, and cyclohexanone; ether solvents such as diethyl ether, isopropyl ether, tetrahydrofuran, dioxane, ethylene glycol dimethyl ether, ethylene glycol diethyl ether, diethylene glycol dimethyl ether, diethylene glycol diethyl ether, diethylene glycol dibutyl ether, propylene glycol monomethyl ether, propylene glycol monobutyl ether, anisole, and phenetole; ester solvents such as ethyl acetate, butyl acetate, isopropyl acetate, and ethylene glycol diacetate; amide solvents such as dimethylformamide, diethylformamide, and N-methylpyrrolidone; and cellosolve solvents such as methyl cellosolve, ethyl cellosolve, and butyl cellosolve. The organic solvent can contribute to a better wet-dispersion of the inorganic oxide fine particles (D).

The liquid comprising the organic solvent may comprise water.

In one embodiment, as the organic solvent comprised in the liquid containing the organic solvent, the organic solvents listed as the organic solvent (B2) and/or the organic solvent (B3) are used.

The inorganic oxide fine particles (D) are preferably used in a state of being dispersed in a liquid containing an organic solvent. The organic solvent is preferably an organic solvent (B2) and/or an organic solvent (B3).

When the inorganic oxide fine particles (D) are used in a state of being dispersed in a liquid containing an organic solvent, it is preferable that the inorganic oxide fine particles (D) are comprised in an amount of 100 to 300 parts by mass based on 100 parts by mass of the liquid, and it is more preferable that the inorganic oxide fine particles (D) are comprised in an amount of 100 to 200 parts by mass. When the amount of the inorganic oxide fine particles (D) is in the above range, dispersibility of the inorganic oxide fine particles is good.

[Aqueous Medium]

In the present disclosure, the aqueous medium is a medium containing water. The aqueous medium may optionally comprise a hydrophilic organic solvent in a range up to several mass %.

Examples of the hydrophilic organic solvent include alcohol solvents such as methanol, ethanol, propanol, and butanol; ketone solvents such as methyl ethyl ketone, acetone, methyl isobutyl ketone, and cyclohexanone; ether solvents such as diethyl ether, isopropyl ether, tetrahydrofuran, dioxane, ethylene glycol dimethyl ether, ethylene glycol diethyl ether, diethylene glycol dimethyl ether, diethylene glycol diethyl ether, propylene glycol monomethyl ether, anisole, and phenetole; ester solvents such as ethyl acetate, butyl acetate, isopropyl acetate, and ethylene glycol diacetate; amide solvents such as dimethylformamide, diethylformamide, and N-methylpyrrolidone; and cellosolve solvents such as methyl cellosolve, ethyl cellosolve, and butyl cellosolve.

Hereinafter, the respective steps of the production method of the present disclosure will be described.

[Organic Solvent Replacement Step]

The organic solvent replacement step is a step of obtaining a silicone resin-organic solvent mixture from a mixture of a silicone resin (A) with an organic solvent (B1) by replacing at least portion of the organic solvent (B1) with an organic solvent (B2) and/or an organic solvent (B3).

In this step, specifically, after the organic solvent (B2) and/or the organic solvent (B3) is added to a mixture of the silicone resin (A) with the organic solvent (B1), at least portion of the organic solvent (B1) may be removed (desolventation).

By replacing at least portion of the organic solvent (B1) with the organic solvent (B2) and/or the organic solvent (B3), a stable aqueous silicone resin emulsion can be obtained. By replacing the organic solvent (B1) with the organic solvent (B2) and/or the organic solvent (B3), an aqueous silicone resin emulsion having a reduced solvent odor can be obtained. This replacement step can be easily performed by using the organic solvent (B1).

Hereinafter, the organic solvent replacement step may be referred to as “organic solvent replacement step (1)”.

As a method for removing the organic solvent (B1), common desolventation methods known to those skilled in the art can be used. Examples of a desolventation method include a method using a common stirring desolventation vessel; a method using a falling-film method; or a method of removing the solvent by heating and/or reducing the pressure using a rotary evaporator or the like.

The mixture of the silicone resin (A) with the organic solvent (B1) may comprise, for example, the silicone resin (A) and the organic solvent (B1) in a mass ratio of 1:2 to 1:0.2 or in a mass ratio of 1:1.5 to 1:0.2.

As the mixture of the silicone resin (A) with the organic solvent (B1), a commercially available product may be used.

In this step, the silicone resin (A) comprises a branched organopolysiloxane (A1).

In this step, the silicone resin (A) may further comprise a linear organopolysiloxane (A2). In this case, the mass ratio of the branched organopolysiloxane (A1) to the linear organopolysiloxane (A2) may be (A1):(A2)=98:2 to 40:60.

In this step, as the organic solvent (B2) and/or the organic solvent (B3), only the organic solvent (B2) may be used, only the organic solvent (B3) may be used, or the organic solvent (B2) and the organic solvent (B3) may be used.

The viscosity of the silicone resin-organic solvent mixture can be adjusted by adding the organic solvent (B2) and/or the organic solvent (B3).

In this step, the organic solvent (B2) and the organic solvent (B3) may be used.

In the silicone resin-organic solvent mixture, the mass ratio of the silicone resin (A) to the total of the organic solvent (B2) and the organic solvent (B3), that is (A):(B2)+(B3), is preferably 1.0:0.2 to 1.0:1.0, and preferably 1.0:0.3 to 1.0:0.8.

The organic solvent (B1) may be 0 to 10 parts by mass or may be 0 to 8 parts by mass, based on 100 parts by mass of the silicone resin-organic solvent mixture. When the content of the organic solvent (B1) is in the above range, there is an advantage that the inorganic oxide fine particles (D) are stably dispersed in the aqueous emulsion resin.

In one embodiment, the silicone resin-organic solvent mixture is substantially free of the organic solvent (B1). Here, “substantially free of” means that it is not contained at all or may be contained as long as it is in an extremely small amount. For example, it may be comprised in an amount of 1.0 part by mass or less or may be comprised in an amount of 0.5 parts by mass or less, based on 100 parts by mass of the silicone resin-organic solvent mixture.

[Mixing Step]

The mixing step is a step of mixing the silicone resin-organic solvent mixture, the organic solvent (B2) and/or the organic solvent (B3), and the inorganic oxide fine particles (D) to obtain a silicone resin mixture.

In the following, the mixing step may be referred to as “mixing step (2)”.

As the method of mixing, a mixing and dispersion treatment method commonly used in the field of coating material (for example, disper agitation and mill dispersion) may be used.

In the mixing step, as an organic solvent, only the organic solvent (B2) may be added, only the organic solvent (B3) may be added, or the organic solvent (B2) and the organic solvent (B3) may be added. The silicone resin mixture comprises both the organic solvent (B2) and the organic solvent (B3).

In other words, when only the organic solvent (B2) is added in the organic solvent replacement step, at least the organic solvent (B3) is added in the mixing step; when only the organic solvent (B3) is added in the organic solvent replacement step, at least the organic solvent (B2) is added in the mixing step; and when the organic solvent (B2) and the organic solvent (B3) are added in the organic solvent replacement step, at least one of the organic solvent (B2) and the organic solvent (B3) may be added in the mixing step. When the organic solvent (B2) and the organic solvent (B3) are added in prescribed amounts in the organic solvent replacement step, the organic solvent (B2) and the organic solvent (B3) may not be added in the mixing step.

The inclusion of the organic solvent (B2) and the organic solvent (B3) can suppress aggregation of the silicone resin (A) and the inorganic oxide fine particles (D) in the silicone resin mixture. Furthermore, the inclusion of the organic solvent (B2) and the organic solvent (B3) can increase the viscosity of the silicone resin mixture, and emulsification in the emulsification step can be facilitated.

When the organic solvent (B2) and the organic solvent (B3) are added in the mixing step, the mass ratio of the organic solvent (B2) and the organic solvent (B3) to be added may be 1.0:0.1 to 1.0:2.0, and preferably may be 1.0:0.3 to 1.0:1.5.

The total amount of the organic solvent (B2) and the organic solvent (B3) to be added in the mixing step is preferably 1 to 50 parts by mass, and more preferably 2 to 40 parts by mass, based on 100 parts by mass of the silicone resin-organic solvent mixture. When the total amount of the organic solvent (B2) and the organic solvent (B3) is in the above range, the viscosity of the silicone resin mixture can be increased and emulsification in the emulsification step can be facilitated.

The amount of the inorganic oxide fine particles (D) to be added in the mixing step is preferably 1 to 15 parts by mass, and more preferably 4 to 12 parts by mass based on 100 parts by mass of the silicone resin (A). When the amount of the inorganic oxide fine particles (D) is in the above range, the weatherability of a resulting coating film can be maintained for a long period of time while the visible light transparency of the coating film is maintained.

In the mixing step, the inorganic oxide fine particles (D) are preferably added in a form of a dispersion prepared by dispersing the particles in the organic solvent (B2) and/or the organic solvent (B3) in advance. In this case, the dispersion can be obtained by subjecting the inorganic oxide fine particles (D) to wet dispersion treatment in the organic solvent (B2) and/or the organic solvent (B3).

In one embodiment, the mixing step is a step of mixing a silicone resin-organic solvent mixture with inorganic oxide fine particles (D) dispersed in an organic solvent (B2) and/or an organic solvent (B3) to obtain a silicone resin mixture.

In one embodiment, the mixing step is a step of mixing a silicone resin-organic solvent mixture with an organic solvent (B2) and/or an organic solvent (B3) and inorganic oxide fine particles (D) dispersed in an organic solvent (B2) and/or an organic solvent (B3) to obtain a silicone resin mixture.

In the silicone resin mixture, the silicone resin (A) may be 50 to 80 parts by mass or may be 60 to 70 parts by mass, based on 100 parts by mass of the silicone resin mixture.

The total amount of the organic solvent (B2) and the organic solvent (B3) in the silicone resin mixture is preferably 10 to 200 parts by mass, more preferably 20 to 100 parts by mass, and even more preferably 30 to 80 parts by mass, based on 100 parts by mass of the silicone resin (A). When the total amount of the organic solvent (B2) and the organic solvent (B3) is in the above range, the viscosity of the silicone resin mixture can be increased and emulsification in the emulsification step can be facilitated.

In the silicone resin mixture, the amount of the organic solvent (B2) is preferably 10 to 70 parts by mass, and more preferably 15 to 60 parts by mass based on 100 parts by mass of the silicone resin (A).

In the silicone resin mixture, the amount of the organic solvent (B3) is preferably 5 to 30 parts by mass, more preferably 7 to 25 parts by mass, and even more preferably 7 to 20 parts by mass, based on 100 parts by mass of the silicone resin (A).

In the silicone resin mixture, the content of the inorganic oxide fine particles (D) is preferably 2 to 20 parts by mass, and more preferably 2 to 10 parts by mass based on 100 parts by mass of the silicone resin (A).

[Emulsification Step]

The emulsification step is a step of subjecting the silicone resin mixture and a mixture of an emulsifier (C) with an aqueous medium to a mechanical emulsification treatment, or subjecting a mixture of the silicone resin mixture with an emulsifier (C) and an aqueous medium to a mechanical emulsification treatment to obtain an aqueous silicone resin emulsion.

Hereinafter, the emulsification step may be referred to as “emulsification step (3)”.

In the emulsification step, the emulsifier (C) may be 1 to 15 parts by mass or may be 1 to 10 parts by mass based on 100 parts by mass of the silicone resin mixture.

In one embodiment, the emulsifier (C) comprises an anionic surfactant and a nonionic surfactant.

The mass ratio of the anionic surfactant to the nonionic surfactant may be 1:0 to 1:10 or may be 1:0 to 1:5.

More specifically, the aqueous silicone resin emulsion can be obtained, for example, by performing any one of the following (1) to (8).

(1) A procedure in which the whole of the silicone resin mixture and the whole of the mixture of the emulsifier (C) with the aqueous medium are once mixed and then subjected to a mechanical emulsification treatment.

(2) A procedure in which portion of the mixture of the emulsifier (C) with the aqueous medium is first added to the whole of the silicone resin mixture, followed by a mechanical emulsification treatment, next the remainder of the mixture of the emulsifier (C) with the aqueous medium is added, and subsequently a mechanical emulsification treatment is conducted.

(3) A procedure in which the emulsifier (C) is once mixed with the whole of the silicone resin mixture and then a mechanical emulsification treatment is conducted while adding the aqueous medium.

(4) A procedure in which portion of the silicone resin mixture and portion of the mixture of the emulsifier (C) with the aqueous medium are first added and subjected to a mechanical emulsification treatment, and subsequently the remainders of the mixtures are added and a mechanical emulsification treatment is conducted.

(5) A procedure in which portion of the silicone resin mixture and the whole of the mixture of the emulsifier (C) with the aqueous medium are first added and subjected to a mechanical emulsification treatment, and subsequently a mechanical emulsification treatment is conducted while the remainder of the silicone resin mixture is added.

(6) A procedure in which portion of the silicone resin mixture is added to and mixed with the whole of the mixture of the emulsifier (C) with the aqueous medium, and then a mechanical emulsification treatment is conducted while the remainder of the silicone resin mixture is added.

(7) A procedure in which portion of the emulsifier (C) is once mixed with the whole of the silicone resin mixture and then a mechanical emulsification treatment is conducted while a mixture of the remainder of the emulsifier with the aqueous medium is added.

(8) A procedure in which portion of the emulsifier (C) and portion of the aqueous medium are once mixed with the whole of the silicone resin mixture and then a mechanical emulsification treatment is conducted while the remainder of the aqueous medium is added.

The above-mentioned mechanical emulsification treatment in the emulsification step means emulsification treatment performed utilizing physical convection. Specific examples of the mechanical emulsification treatment include agitation treatment (500 to 5,000 rpm) using a disper or a homomixer, and high speed rotary agitation treatment.

The high speed rotary agitation treatment is an agitation treatment by rotating a stirrer at a high speed. The high speed rotation may be conducted in such an embodiment in which agitation is conducted at 5,000 to 30,000 rpm for example. Specific examples of the high speed rotary agitation treatment include high speed rotary agitation treatment using, for example, CLEARMIX, CLEARMIX W-MOTION (manufactured by M Technique Co., Ltd.).

The average particle diameter of the aqueous silicone resin emulsion is preferably 100 to 500 nm, and more preferably 100 to 400 nm.

The average particle diameter of a resin emulsion as herein referred to is an average particle diameter determined by a dynamic light scattering method, and specifically, it can be measured using an electrophoretic light scattering photometer ELSZ Series (manufactured by Otsuka Electronics Co., Ltd.) or the like.

The aqueous silicone resin emulsion is suitable for preparing an aqueous clear coating composition, and exhibits good storage stability.

The production method of the present disclosure may further include other steps.

Examples of such other steps include a step of adding a separately prepared emulsion to the aqueous silicone resin emulsion obtained in the emulsification step, a step of further adding inorganic oxide fine particles (D), and a step of adding other additives.

Specific examples of the production method of the present disclosure will be shown below as a first embodiment and a second embodiment, and the present disclosure is not limited to these embodiments. Unless otherwise specified, each step can be performed in the same manner as the above-described steps, and the above-described components can be used as respective components.

### First Embodiment

In the first embodiment, the method for producing an aqueous clear coating composition comprising an aqueous silicone resin emulsion includes the following steps.

Organic solvent replacement step (1) of obtaining a silicone resin-organic solvent mixture from a mixture of a silicone resin (A) with an organic solvent (B1) by replacing at least portion of the organic solvent (B1) with an organic solvent (B2) and/or an organic solvent (B3);

mixing step (2) of mixing the silicone resin-organic solvent mixture with an organic solvent (B2) and/or an organic solvent (B3) and inorganic oxide fine particles (D) to obtain a silicone resin mixture;

emulsification step (3) of subjecting the silicone resin mixture and a mixture of an emulsifier (C) with an aqueous medium to a mechanical emulsification treatment, or subjecting a mixture of the silicone resin mixture with an emulsifier (C) and an aqueous medium to a mechanical emulsification treatment to obtain an aqueous silicone resin emulsion.

In the first embodiment, the silicone resin (A) to be used for the preparation of the silicone resin-organic solvent mixture comprises a branched organopolysiloxane (A1).

In the first embodiment, the silicone resin (A) to be used for the preparation of the silicone resin-organic solvent mixture preferably comprises a linear organopolysiloxane (A2) in addition to the branched organopolysiloxane (A1). In this case, it is easier to adjust the viscosity of the silicone resin-organic solvent mixture and/or the viscosity in the emulsification step to appropriate ranges.

### Second Embodiment

In the second embodiment, the method for producing an aqueous clear coating composition comprising an aqueous silicone resin emulsion includes the following steps.

Organic solvent replacement step (1) of obtaining a silicone resin-organic solvent mixture from a mixture of a silicone resin (A) with an organic solvent (B1) by replacing at least portion of the organic solvent (B1) with an organic solvent (B2) and/or an organic solvent (B3);

mixing step (2) of mixing the silicone resin-organic solvent mixture with an organic solvent (B2) and/or an organic solvent (B3) and inorganic oxide fine particles (D) to obtain a silicone resin mixture;

emulsification step (3) of subjecting the silicone resin mixture and a mixture of an emulsifier (C) with an aqueous medium to a mechanical emulsification treatment, or subjecting a mixture of the silicone resin mixture with an emulsifier (C) and an aqueous medium to a mechanical emulsification treatment to obtain an aqueous silicone resin emulsion (this may be referred to as “silicone resin emulsion (I)”);

step (4) of mixing the silicone resin emulsion (I) with an emulsion comprising a linear organopolysiloxane (A2) (this emulsion may be referred to as “emulsion (II)”).

In the second embodiment, the silicone resin (A) to be used for the preparation of the silicone resin-organic solvent mixture comprises a branched organopolysiloxane (A1).

In the second embodiment, the silicone resin (A) to be used for the preparation of the silicone resin-organic solvent mixture preferably comprises a linear organopolysiloxane (A2) in addition to the branched organopolysiloxane (A1).

In the second embodiment, the emulsion (II) can be obtained by a method similar to the step described above except that the inorganic oxide fine particles (D) are not used in the mixing step. As the organic solvent (B), the emulsifier (C), and the aqueous medium, those the same as the above can be used.

In the step (4), the silicone resin emulsion (I) and the emulsion (II) may be mixed, for example, at a solid mass ratio of the branched organopolysiloxane (A1) to the linear organopolysiloxane (A2) in the resulting mixture of 98:2 to 40:60.

In the second embodiment, the blending amount ratio of the silicone resin emulsion (I) to the emulsion (II) may be appropriately determined when forming a coating material. The second embodiment thus has an advantage that the physical properties of a resulting coating film can be appropriately adjusted according to the performance required by the application.

[Preparation of Aqueous Clear Coating Composition]

The aqueous clear coating composition can be obtained by mixing the aqueous silicone resin emulsion with a pigment, additives, and the like, which are used as necessary, by using a stirrer commonly used by those skilled in the art, for example, disper.

Since the aqueous clear coating composition obtained by the method of the present disclosure contains the aqueous silicone resin emulsion comprising the branched organopolysiloxane (A1), the aqueous clear coating composition can form a coating film superior in physical properties such as toughness and weatherability. In addition, since the aqueous clear coating composition obtained by the method of the present disclosure comprises a silicone resin emulsion having superior storage stability, the aqueous clear coating composition also has an advantage of being superior in storage stability.

Since the aqueous clear coating composition obtained by the method of the present disclosure comprises the inorganic oxide fine particles (D), the aqueous clear coating composition has an advantage of being capable of forming a clear coating film with further improved weatherability. In addition, the aqueous clear coating composition has characteristics of having visible light transmissibility, being superior in clear performance, while having good ultraviolet blocking property. It therefore has an advantage of being capable of preventing ultraviolet degradation of a coating layer and a substrate existing under a clear coating film as well.

The aqueous clear coating composition may comprise a pigment other than the inorganic oxide fine particles (D) as necessary. Such other pigment is required to be of a type and quantity that are not significantly detrimental to the transparency of the aqueous clear coating composition. The other pigment is not particularly limited as long as the above conditions are satisfied. Examples of the other pigment include extender pigments, inorganic coloring pigments, and organic pigments.

The aqueous clear coating composition may as necessary be mixed with additives commonly used, such as viscosity modifiers, fillers, dispersants, ultraviolet absorbers, light stabilizers, antioxidants, matting agents, antifreeze agents, algaecides, defoamers, film-forming aid, antiseptics, fungicides, and reaction catalysts.

The aqueous clear coating composition preferably comprises a viscosity modifier in an amount of 0.01 to 20 mass % based on the mass of the resin solid contents. The amount of the viscosity modifier is preferably 0.05 to 10 mass %, and more preferably 0.5 to 5 mass %, based on the mass of the resin solid content.

Examples of the viscosity modifiers include polyamide-based viscosity modifiers, urethane-based viscosity modifiers, polycarboxylic acid-based viscosity modifiers, cellulose-based viscosity modifiers, inorganic layered compound-based viscosity modifiers, and aminoplast-based viscosity modifiers.

Examples of the polyamide-based viscosity modifier include fatty acid amides, polyamides, acrylic amides, long-chain polyamine amides, amine amide, and salts thereof (for example, phosphates).

Examples of the urethane-based viscosity modifier include polyether polyol-based urethane prepolymers and urethane-modified polyether-based viscosity modifiers.

Examples of the polycarboxylic acid-based viscosity modifier include high-molecular weight polycarboxylic acids, high-molecular weight unsaturated acid polycarboxylic acids, and partially amidated products thereof.

Examples of the cellulose-based viscosity modifier include cellulose-based viscosity modifiers such as hydroxyethyl cellulose and hydroxypropyl cellulose.

Examples of the inorganic layered compound-based viscosity modifier include layered compounds such as montmorillonite, bentonite and clay.

Examples of the aminoplast-based viscosity modifier include hydrophobically modified ethoxylate aminoplast-based associated viscosity modifiers.

The viscosity modifiers may be used singly or two or more of them may be used in combination.

As the viscosity modifier, commercially available products thereof may be used. Examples of commercially available viscosity modifiers include:

DISPARLON AQ-600 (produced by Kusumoto Chemicals, Ltd.), Anti-Terra-U (produced by BYK Chemie), Disperbyk-101, Disperbyk-130 (produced by BYK Chemie), which are polyamide based viscosity modifiers;

Anti-Terra-203, 204 (produced by BYK Chemie), Disperbyk-107 (produced by BYK Chemie), BYK-P104, BYK-P105 (produced by BYK Chemie), Primal ASE-60, Primal TT-615 (produced by The Dow Chemical Company), Viscalex HV-30 (produced by BASF), SN-THICKENER 617, SN-THICKENER 618, SN-THICKENER 630, SN-THICKENER 634, SN-THICKENER 636 (produced by San Nopco Ltd.), which are polycarboxylic acid based viscosity modifiers;

ADEKA NOL UH-814N, UH-752, UH-750, UH-420, UH-462 (produced by ADEKA Corporation), SN-THICKENER 621N, SN-THICKENER 623N (produced by San Nopco Ltd.), RHEOLATE 244, 278 (produced by Elementis plc), which are urethane based viscosity modifiers;

HEC Daicel SP600N (produced by Daicel FineChem Ltd.), which is a cellulose based viscosity modifier;

BENTONE HD (produced by Elements Co.), which is a layered compound based viscosity modifier; and

Optiflo H 600 VF (produced by BYK Chemie), which is an aminoplast based viscosity modifier.

The viscosity modifier preferably includes one or more species of polycarboxylic acid-based viscosity modifiers and urethane-based viscosity modifiers. A viscosity modifier including a polycarboxylic acid-based viscosity modifier is more preferred. When the viscosity modifier includes a polycarboxylic acid-based viscosity modifier, it is preferable to use ammonia as a neutralizer. In the case where the viscosity modifier includes a polycarboxylic acid-based viscosity modifier, using ammonia as a neutralizer is advantageous in that gel fraction can be maintained in a favorable range. The gel fraction refers to a mass fraction of extraction insoluble portion of a dried coating film in an organic solvent, and it can be measured in accordance with JIS K 6796.

In one embodiment, the clear coating composition of the present disclosure may not comprise an organic ultraviolet absorber commonly used in clear coating compositions. The inclusion of the inorganic oxide fine particles (D) in the clear coating composition of the present disclosure imparts ultraviolet blocking performance while maintaining the visible light transparency, which is a desired property in a clear coating composition, even without organic ultraviolet absorber, and it is possible to maintain ultraviolet blocking property for a long period of time. Examples of the organic ultraviolet absorber include benzotriazole-based ultraviolet absorbers and triazine-based ultraviolet absorbers.

In one embodiment, the clear coating composition of the present disclosure may comprise an organic ultraviolet absorber commonly used. Organic ultraviolet absorbers are high in visible light transmittance and superior in ultraviolet ray blocking property. By using an organic ultraviolet absorber, visible light transparency and ultraviolet ray blocking property can be imparted to a coating film.

[Formation of Coating Film]

The aqueous clear coating composition produced by the method of the present disclosure can be applied to various articles to be coated.

The article to be coated is preferably, for example, a building material to be used for a wall surface such as an inner wall or an outer wall of a building such as a house or a high-rise building, or a roof.

The aqueous clear coating composition can be used as an aqueous coating composition for coating building materials or an aqueous coating composition for coating buildings. The aqueous clear coating composition can be used, for example, as an aqueous clear coating composition for coating building materials or an aqueous clear coating composition for coating buildings.

The building material suitable as an article to be coated with the aqueous clear coating composition is not particularly limited, and examples thereof include inorganic building materials, wooden building materials, metal building materials, and plastic building materials.

Examples of the inorganic building material include ceramic building materials, glass substrates, and the like described in JIS A 5422, JIS A 5430, for example, calcium silicate plate, pulp cement plate, slag gypsum plate, magnesium carbonate plate, asbestos pearlite plate, wood cement plate, hard wood cement plate, concrete plate, and lightweight cellular concrete plate.

Examples of the wooden building material include conversion lumber, laminated wood, plywood, particle board, fiber board, improved wood, chemical treated wood, and floorboard.

Examples of the plastic building material include acrylic plate, polyvinyl chloride plate, polycarbonate plate, ABS plate, polyethylene terephthalate plate, and polyolefin plate.

Examples of the metal building material include aluminum plate, iron plate, zinc galvanized steel plate, aluminum galvanized steel plate, stainless steel plate, and tin plate.

The article to be coated may have been coated with a sealer composition, an undercoat coating composition, or the like in advance, as necessary. Examples of the undercoat coating composition include aqueous undercoat coating compositions containing pigments (for example, various coloring pigments). The aqueous clear coating composition also has an advantage of well adhering to coating layers of various undercoat coating compositions containing coloring pigments.

The method for applying the aqueous clear coating composition is not particularly limited, and examples thereof include coating methods commonly used such as immersion, brush, roller, roll coater, air spray, airless spray, curtain flow coater, roller curtain coater, and die coater. These can be appropriately selected according to the type of a building material, etc.

The aqueous clear coating composition is preferably applied such that the dry film thickness is 30 μm to 1 mm, and more preferably 50 to 500 μm.

After applying the aqueous clear coating composition, a drying step may be performed, as necessary. Drying conditions can be appropriately selected depending on the shape, size, and the like of the article to be coated. Specific examples of the drying conditions include conditions such as heating at a temperature of 50 to 200° C. for 1 to 60 minutes.

The method for preparing the aqueous clear coating composition is not particularly limited. For example, the aqueous clear coating composition can be prepared by mixing ingredients using a mixing machine such as a sand grind mill, a ball mill, a blender, a paint shaker, or a disper, a dispersing machine, a kneading machine, or the like.

The present disclosure provides the following [1] to [10].

[1] A method for producing an aqueous clear coating composition comprising an aqueous silicone resin emulsion, the method comprising:

obtaining a silicone resin-organic solvent mixture from a mixture of a silicone resin (A) with an organic solvent (B1) by replacing at least portion of the organic solvent (B1) with an organic solvent (B2) and/or an organic solvent (B3);

mixing the silicone resin-organic solvent mixture, the organic solvent (B2) and/or the organic solvent (B3), and inorganic oxide fine particles (D) to obtain a silicone resin mixture; and

subjecting the silicone resin mixture and a mixture of an emulsifier (C) with an aqueous medium to a mechanical emulsification treatment, or subjecting a mixture of the silicone resin mixture with an emulsifier (C) and an aqueous medium to a mechanical emulsification treatment to obtain an aqueous silicone resin emulsion,

wherein the silicone resin (A) comprises a branched organopolysiloxane (A1) having a weight average molecular weight of 5,000 to 300,000,

wherein the organic solvent (B1) is a hydrocarbon-based solvent having a solubility in water of 1 g/100 g-H₂O or less,

wherein the organic solvent (B2) comprises at least one solvent selected from the group consisting of an alcohol, an alkylene glycol monoalkyl ether, and an alkylene glycol dialkyl ether, and the organic solvent (B2) has a solubility of less than 5 g/100 g-H₂O in water,

wherein the organic solvent (B3) comprises at least one solvent selected from the group consisting of an alcohol, an alkylene glycol monoalkyl ether, and an alkylene glycol dialkyl ether, and the organic solvent (B3) has a solubility of 5 g/100 g-H₂O or more in water, and

wherein the silicone resin mixture comprises both the organic solvent (B2) and the organic solvent (B3).

[2] The production method described in [1], wherein the silicone resin (A) comprises a linear organopolysiloxane (A2) having a weight average molecular weight of 1,000 to 30,000.
[3] The production method described in [1] or [2], further comprising mixing the aqueous silicone resin emulsion with a silicone resin emulsion comprising a linear organopolysiloxane (A2) having a weight average molecular weight of 1,000 to 30,000 prepared beforehand.
[4] The production method described in [2] or [3], wherein a mass ratio (A1):(A2) of the branched organopolysiloxane (A1) to the linear organopolysiloxane (A2) is 98:2 to 40:60 in the aqueous clear coating composition.
[5] The production method described in any one of [1] to [4], wherein a mass ratio (A):(B) of the silicone resin (A) to the organic solvent (B) is 1:1 to 1:0.2 in the aqueous clear coating composition.
[6] The production method described in any one of [1] to [5], wherein a mass ratio (B2):(B3) of the organic solvent (B2) to the organic solvent (B3) is 1:0.2 to 1:2 in the aqueous clear coating composition.
[7] The production method described in any one of [1] to [6], wherein the emulsifier
[8] The production method described in any one of [1] to [7], wherein a content of the inorganic oxide fine particles (D) is 3 to 20 parts by mass based on 100 parts by mass of a solid content of the silicone resin (A) in the aqueous clear coating composition.
[9] The production method described in any one of [1] to [8], wherein the inorganic oxide fine particles (D) comprise at least one selected from a group consisting of titanium oxide, zinc oxide and cerium oxide.
[10] The production method described in any one of [1] to [9], wherein the inorganic oxide fine particles (D) have an average particle diameter of 20 to 300 nm.

### EXAMPLES

The present disclosure will be described more specifically with reference to the following examples, but the present disclosure is not limited to the examples. In the examples, “parts” and “%” are on a mass basis unless otherwise indicated.

In Table 1 are shown the silicone resins used in the examples and the comparative examples. In Table 1, “m/n” represents the values of m and n taken when the silicone resin is represented by the following formula.

[R¹SiO_{3/2}]ₘ[R²₂SiO]ₙ

TABLE 1

| | | | Structure of | Weight average | | | Solid |
|---|---|---|---|---|---|---|---|
| Silicone | Product | Name of | organo- | molecular | | Organic | concentration |
| resin | name | manufacturer | polysiloxane | weight | m/n | solvent (B) | (%) |
| (A1-1) | SR-2400 | Dow Corning Toray Silicone | Branched | 20,000 | 180/60 | Toluene | 50 |
| | | Co., Ltd. | | | | (B1-1) | |
| (A1-2) | X40-2406M | Shin-Etsu Chemical Co., Ltd. | Branched | 40,000 | 510/80 | Xylene | 40 |
| | | | | | | (B1-2) | |
| (A1-3) | 804 RESIN | Dow Corning Toray Silicone | Branched | 5,000 | 60/20 | Toluene | 60 |
| | | Co., Ltd. | | | | (B1-1) | |
| (A2-1) | YF-3800 | Momentive Performance | Linear | 4,000 | 0/60 | — | 100 |
| | | Materials Inc. | | | | | |
| (A2-2) | XF-3905 | Momentive Performance | Linear | 20,000 | 0/270 | — | 100 |
| | | Materials Inc. | | | | | |

The organic solvent (B1), the organic solvent (B2) and the organic solvent (B3), the emulsifier (C) and the inorganic oxide fine particles (D) used in the examples and the comparative examples are as follows.

Organic Solvent (B1):

Organic solvent (B1-1): toluene, solubility in water: 0.05 g/100 g-H₂O, boiling point: 111° C.

Organic solvent (B1-2): xylene, solubility in water: 0.15 g/100 g-H₂O, boiling point: 139° C.

Organic Solvent (B2):

Organic solvent (B2-1): diethylene glycol dibutyl ether, solubility in water: 0.3 g/100 g-H₂O, boiling point: 256° C.

Organic solvent (B2-2): ethylene glycol dibutyl ether, solubility in water: 0.2 g/100 g-H₂O, boiling point: 202° C.

Organic Solvent (B3)

Organic solvent (B3-1): propylene glycol monobutyl ether, solubility in water: 6.0 g/100 g-H₂O, boiling point: 170° C.

Organic solvent (B3-2): propylene glycol monopropyl ether, solubility in water: 19 g/100 g-H₂O, boiling point: 149° C.

Emulsifier (C):

Emulsifier (C1): nonionic surfactant (polyoxyethylene alkyl ether), NL-40, manufactured by DKS Co. Ltd.; component content: 100 mass %

Emulsifier (C2): anionic surfactant (polyoxyalkylene alkenyl ether sulfate ester salt), LATEMUL PD-104, manufactured by Kao Corporation; component content: 20 mass %

Emulsifier (C3): anionic surfactant (alkyl diphenyl ether sulfate ester salt), PELEX SS-H, manufactured by Kao Corporation; component content: 50 mass %

Inorganic Oxide Fine Particles (D):

Inorganic oxide fine particles (D1): zinc oxide, FINEX-52W-LP-2, manufactured by Sakai Chemical Industry Co., Ltd.; average particle diameter: 20 nm

Inorganic oxide fine particles (D2): zinc oxide, NANOFINE-50LP, manufactured by Sakai Chemical Industry Co., Ltd.; average particle diameter: 20 nm

Inorganic oxide fine particles (D3): titanium oxide, TTO-51, manufactured by Ishihara Sangyo Kaisha, Ltd.; average particle diameter: 20 nm

### Example 1

### <Organic Solvent Replacement Step>

To a sealable reaction vessel 183.2 parts by mass of silicone resin (A1-1) (a mixture of product name: SR-2400 (solid concentration: 50 mass % and toluene (50 mass % of organic solvent (B1-1))), 1.9 parts by mass of YF-3800 as silicone resin (A2-1), 29.7 parts by mass of diethylene glycol dibutyl ether as organic solvent (B2-1), and 14.0 parts by mass of propylene glycol monobutyl ether as organic solvent (B3-1) were added, and the organic solvent (B1) was distilled off while being heated under sealing and reduced pressure to afford a silicone resin-organic solvent mixture (solid concentration: 68 mass %). The residual amount of the organic solvent (B1) was measured with a gas chromatograph GC-2014 (manufactured by Shimadzu Corporation), and it was confirmed that the organic solvent (B1) had been substantially completely removed (the content was less than 0.1 parts by mass based on 100 parts by mass of the aqueous clear coating composition).

<Inorganic Oxide Fine Particle Wet Treatment Step>

Into a stainless steel container 50 parts by mass of FINEX-52W-LP-2 (zinc oxide) as inorganic oxide fine particles (D1) and 27 parts by mass of diethylene glycol dibutyl ether as organic solvent (B2-1) were charged, and they were dispersed at 5,000 rpm for 30 minutes using a disper to afford a dispersion slurry (solid concentration: 65 mass %) of the inorganic oxide fine particles (D1).

<Mixing Step>

Into a stainless steel container 137.2 parts by mass of the silicone resin-organic solvent mixture and 8.6 parts by mass of a dispersion slurry of the inorganic oxide fine particles (D1) (containing 3.0 g parts by mass of organic solvent (B2-1) as a dispersion medium) were charged, and the mixture was stirred at 1,000 rpm for 10 minutes using a disper to afford a silicone resin mixture.

<Emulsification Step>

To 145.8 parts by mass of the silicone resin mixture obtained in the mixing step, 6.1 parts by mass of a nonionic surfactant NL-40 was added as emulsifier (C-1) under stirring at 1,000 rpm using a disper, and the mixture was stirred for 10 minutes. Subsequently, 9.6 parts by mass (component amount: 1.9 parts by mass) of an anionic surfactant LATEMUL PD-104 as emulsifier (C-2) was added, the mixture was stirred for 30 minutes, and 129.1 parts by mass of ion-exchanged water was further added to afford silicone resin emulsion (S-1) (solid concentration: 36.6 mass %). The obtained silicone resin emulsion (S-1) had an average particle diameter of 250 nm.

<Preparation of Aqueous Clear Coating Composition>

To 100 parts by mass of the silicone resin emulsion (S-1) obtained above 0.4 parts by mass of 25% ammonia water was added, and then 0.2 parts by mass of Primal ASE-60 (manufactured by The Dow Chemical Company) as an alkali swelling type viscosity control agent was added and mixed. Subsequently, 36.4 parts by mass of tap water was mixed, and 2.2 parts by mass of DIBUTYL TIN OXIDE (manufactured by Nitto Kasei Co., Ltd.) as a curing catalyst was added and mixed to afford an aqueous clear coating composition.

### Examples 2 to 28

Aqueous clear coating compositions were obtained by changing the conditions of Example 1 to the conditions shown in Tables 2 to 5. The silicone resin emulsions obtained in the examples were designated as (S-2) to (S-28), respectively.

### Example 29

An aqueous clear coating composition was obtained in the same manner as in Example 1 except that in the organic solvent replacement step, only the organic solvent (B3-1) was added as an organic solvent, and in the mixing step, the organic solvent (B2-1) was added together with the dispersion slurry (containing 3.0 parts by mass of the organic solvent (B2-1) as a dispersion medium) of the silicone resin-organic solvent mixture and the inorganic oxide fine particles (D1).

### Example 30

An aqueous clear coating composition was obtained in the same manner as in Example 1 except that in the organic solvent replacement step, only the organic solvent (B2-1) was added as organic solvent, and in the mixing step, the organic solvent (B3-1) was added together with the dispersion slurry (containing 3.0 parts by mass of the organic solvent (B2-1) as a dispersion medium) of the silicone resin-organic solvent mixture and the inorganic oxide fine particles (D1).

### Example 31

An aqueous clear coating composition was obtained in the same manner as in Example 1 except that in the organic solvent replacement step, the amounts of the organic solvent (B2-1) and the organic solvent (B3-1) added were changed to the amounts shown in Table 5, and in the mixing step, the organic solvent (B2-1) and the organic solvent (B3-1) were added in the amounts shown in Table 5 together with the dispersion slurry (containing 3.0 parts by mass of the organic solvent (B2-1) as a dispersion medium) of the silicone resin-organic solvent mixture and the inorganic oxide fine particles (D1).

### Example 32

A 6.1 parts by mass of emulsifier (C1), 9.6 parts by mass of emulsifier (C2) and 129.1 parts by mass of ion-exchanged water were mixed in advance, and an aqueous solution of the emulsifiers (a mixture of (C1) with (C2)) was prepared under stirring at 1,000 rpm using a disper.

An aqueous clear coating composition was obtained in the same manner as in Example 1 except that in the emulsification step, 144.8 parts by mass of an aqueous solution of emulsifiers (a mixture of (C1) with (C2)) was added to the silicone resin mixture obtained in the mixing step under stirring at 1,000 rpm using a disper and the mixture was stirred for 30 minutes to afford a silicone resin emulsion.

### Comparative Example 1

### <Organic Solvent Replacement Step>

The organic solvent replacement step was performed in the same manner as in Example 1 to afford a silicone resin-organic solvent mixture (solid concentration: 68 mass %). The residual amount of the organic solvent (B1) was measured with a gas chromatograph GC-2014 (manufactured by Shimadzu Corporation), and it was confirmed that the organic solvent (B1) had been substantially completely removed.

<Emulsification Step>

To 140.2 parts by mass of the silicone resin mixture obtained in the mixing step, 6.2 parts by mass of a nonionic surfactant NL-40 as emulsifier (C-1) was added under stirring at 1,000 rpm using a disper, and the mixture was stirred for 10 minutes. Subsequently, 9.6 parts by mass of an anionic surfactant LATEMUL PD-104 as emulsifier (C-2) was added, the mixture was stirred for 30 minutes, and 129.1 parts by mass of ion-exchanged water was further added to afford silicone resin emulsion (s-1) (solid concentration: 36.6 mass %). The obtained silicone resin emulsion (s-1) had an average particle diameter of 250 nm.

<Step of Post-Mixing of Inorganic Oxide Fine Particles>

Into the reactor 277.3 parts by mass of the silicone resin emulsion obtained in the emulsification step and 8.6 parts by mass of a dispersion slurry of the inorganic oxide fine particles (D1) were charged, and the mixture was stirred at 1,000 rpm for 10 minutes using a disper to afford a silicone resin mixture. As the dispersion slurry of the inorganic oxide fine particles (D1), a dispersion slurry obtained in the same zinc oxide wet treatment step as in Example 1 was used.

<Preparation of Aqueous Clear Coating Composition>

Using the obtained silicone resin emulsion, an aqueous clear coating composition was prepared in the same manner as in Example 1.

### Comparative Examples 2 to 9

Aqueous clear coating compositions were obtained by changing the conditions of Example 1 to the conditions shown in Table 6. The silicone resin emulsions obtained in the examples were designated as (s-2) to (s-9), respectively.

### Example 33

In Example 33, two silicone resin emulsions (S-12) and (s-8) described below were mixed such that the resin solid content ratio was 1:1. This leads to, as the whole silicone resin, (A1):(A2)=98:2, (A):(B)=1:0.5, (B2):(B3)=1:0.43, and a content (parts by mass) of (D) based on 100 parts by mass of (A) of 6.0 parts by mass.

The silicone resin emulsion (S-12) is the silicone resin emulsion obtained in Example 12, in which the amount of the inorganic oxide fine particles (D) was adjusted to 12 parts by mass based on 100 parts by mass of the solid content of the silicone resin (A). The silicone resin emulsion (s-8) is the silicone resin emulsion obtained in Comparative Example 8, and is free of inorganic oxide fine particles (D).

### Example 34

In Example 34, two silicone resin emulsions (S-13) and (s-9) described below were mixed such that the resin solid content ratio was 98:2. This leads to, as the whole silicone resin, (A1):(A2)=98:2, (A):(B)=1:0.5, (B2):(B3)=1:0.43, and a content (parts by mass) of (D) based on 100 parts by mass of (A) of 5.9 parts by mass.

The silicone resin emulsion (S-13) is the silicone resin emulsion obtained in Example 13, and is an emulsion prepared using (A1) alone as the silicone resin (A). The silicone resin emulsion (s-9) is the silicone resin emulsion obtained in Comparative Example 9 using (A2) alone as the silicone resin (A), and is free of inorganic oxide fine particles (D).

<Preparation of Test Sheet>

A siding board was spray-coated with an aqueous undercoat coating composition containing a coloring pigment, 0-DE POWER 390 for spray (silicon acrylic resin-based: manufactured by Nippon Paint Industrial Coatings Co., Ltd.) such that a dry film thickness of 50 μm was achieved, and dried at 100° C. for 3 minutes with a jet dryer (wind speed: 10 m/s) to afford an undercoat coating film.

Subsequently, an aqueous clear coating composition obtained in an example or a comparative example was spray-coated on the undercoat coating film such that a dry film thickness of 30 μm was achieved, and dried at 100° C. for 10 minutes with a jet dryer (wind speed: 10 m/s) to afford a test plate.

<Evaluation Item>

### [Evaluation of Dispersibility of Silicone Resin Emulsion]

The aqueous silicone resin emulsion obtained in each of the Examples and Comparative Examples was filtered through a 200 mesh filter, and then the state of the resin emulsion was visually observed and the average particle diameter was measured, whereby the dispersibility of the emulsion was evaluated. Evaluation criteria are as follows

◯: No coarse particles having a particle diameter of 2 μm or more were observed in the measurement of the average particle diameter, and no separation/aggregates or the like occurred in the visual observation

◯Δ: In the measurement of the average particle diameter, coarse particles having a particle diameter of 2 μm or more can be found, but no separation/aggregates or the like occurred in the visual observation

Δ: A small amount of aggregates occurred in the visual observation

x: Separation/aggregates occurred in the visual observation

[Evaluation of Storage Stability of Silicone Resin Emulsion]

Each of the aqueous silicone resin emulsions obtained in the above Examples and Comparative Examples was filtered through a 200 mesh filter and then was allowed to stand at 40° C. for 3 months. The state of the silicone resin emulsion after standing was visually observed and storage stability was evaluated. Evaluation criteria are as follows.

◯: Separation/sedimentation did not occur.

x: Separation/sedimentation occurred.

[Clear Coating Film Appearance (Initial Appearance of Coating Film after Coating)]

Each of the aqueous clear coating compositions obtained in Examples and Comparative Examples was applied to a quartz glass plate (a substrate having no absorption in the ultraviolet range) by using a doctor blade (2 mil) to have a dried film thickness of 10 μm and was dried at 160° C. for 10 minutes, and thus an evaluation test plate was obtained. The state of the obtained evaluation test plate was visually observed and the coating film appearance was evaluated. Evaluation criteria are as follows.

◯: Slight cloudiness caused by inorganic oxide fine particles is observed in the coating film.

Δ: Cloudiness caused by inorganic oxide fine particles and/or aggregates of inorganic oxide fine particles are observed in the coating film.

x: Significant cloudiness caused by inorganic oxide fine particles and/or many aggregates of inorganic oxide fine particles are observed in the coating film.

[Measurement of Ultraviolet Transmittance of Clear Coating Film]

Each of the aqueous clear coating compositions obtained in Examples and Comparative Examples was applied to a quartz glass plate (a substrate having no absorption in the ultraviolet range) by using a doctor blade (2 mil) to have a dried film thickness of 10 μm and then was dried at 160° C. for 10 minutes, and thus an evaluation test plate was obtained.

The light transmittance at the wavelength of 280 nm to 780 nm of the evaluation test plate obtained above was measured using an ultraviolet visible spectrophotometer (UV-3100, manufactured by Shimadzu Corporation). The ultraviolet transmittance was measured according to the following method, and the obtained value was taken as the initial ultraviolet transmittance.

<Method for Measuring Ultraviolet Transmittance>

The light transmittance (%) in the wavelength range of 280 to 380 nm was determined as an ultraviolet transmittance (%). Specifically, a transmission spectrum from 280 nm to 380 nm in wavelength was measured, and an ultraviolet transmittance was obtained from the integrated value. More specifically, light transmittance in the wavelength range of 280 to 380 nm was measured at 51 points with the increment of 2 nm, and the average value thereof was taken as an ultraviolet transmittance.

[Evaluation of Acid Resistance]

The quartz glass plate obtained as described above was immersed in an aqueous sulfuric acid solution with an adjusted pH of 3.0 at 23° C. for 24 hours, then the ultraviolet transmittance after an acid resistance evaluation test was measured by the same method as described above, and the acid resistance was evaluated based on the rate of change from the initial ultraviolet transmittance. Evaluation criteria are as follows.

◯: The change from the initial ultraviolet transmittance is 100% or more and less than 150%, and almost no elution of zinc oxide from the coating film is observed.

x: The change from the initial ultraviolet transmittance is 150% or more, and elution of zinc oxide from the coating film is observed.

[Evaluation of Weatherability (Evaluation of Coating Film Appearance after Accelerated Weatherability Test)]

The test plate was subjected to an accelerated weatherability test for 10,000 hours using a Sunshine Weather Meter S80 (manufactured by Suga Test Instruments Co., Ltd.) which is a Sunshine Carbon arc lamp accelerated weatherability tester specified in JIS B 7753. Operating conditions are as follows.

Irradiance: 255 W/m²

Black panel temperature: 63° C.

Water injection time: 18 minutes in 120 minutes

The state of the evaluation test plate after the accelerated weatherability test was visually observed and the appearance of the coating film was evaluated. Evaluation criteria are as follows.

◯: No change is observed

Δ: Whitening is observed in a part of the coating film

x: Remarkable whitening and/or delamination was observed in the coating film

The results of the evaluations are shown in Tables 2 to 6

TABLE 2

| | | | | | | Examples | | | | | | | | |
|---|---|---|---|---|---|---|---|---|---|---|---|---|---|---|
| | | | | | | 1 | 2 | 3 | 4 | 5 | 6 | 7 | 8 | 9 |
| Aqueous | Silicone | (A1-1) | | | parts by mass | 91.6 | 84.2 | 65.5 | 92.5 | 28.1 | 91.6 | 91.6 | 91.6 | 91.6 |
| silicone | resin | (A1-2) | | | parts by mass | | | | | | | | | |
| resin | (A) | (A1-3) | | | parts by mass | | | | | | | | | |
| emulsion | | (A2-1) | | | parts by mass | 1.9 | 9.4 | 28.1 | 0.9 | 65.5 | 1.9 | 1.9 | 1.9 | 1.9 |
| | | (A2-2) | | | parts by mass | | | | | | | | | |
| | Organic | (B1-1) | | | parts by mass | 91.6 | 84.2 | 65.5 | 91.6 | 91.6 | 91.6 | 91.6 | 91.6 | 91.6 |
| | solvent | (B1-2) | | | parts by mass | | | | | | | | | |
| | (B) | (B2-1) | | | parts by mass | 32.7 | 32.7 | 32.7 | 32.7 | 32.7 | 16.4 | 49.1 | 42.5 | 37.4 |
| | | (B2-2) | | | parts by mass | | | | | | | | | |
| | | (B3-1) | | | parts by mass | 14.0 | 14.0 | 14.0 | 14.0 | 14.0 | 7.0 | 21.0 | 4.2 | 9.4 |
| | | (B3-2) | | | parts by mass | | | | | | | | | |
| | Emulsifier | (C1) | | | parts by mass | 6.1 | 6.1 | 6.1 | 6.1 | 6.1 | 6.1 | 6.1 | 6.1 | 6.1 |
| | (C) | (C2) | | | parts by mass | 1.9 | 1.9 | 1.9 | 1.9 | 1.9 | 1.9 | 1.9 | 1.9 | 1.9 |
| | | (C3) | | | parts by mass | | | | | | | | | |
| | Inorganic | (D1) | | | parts by mass | 5.6 | 5.6 | 5.6 | 5.6 | 5.6 | 5.6 | 5.6 | 5.6 | 5.6 |
| | oxide fine | (D2) | | | parts by mass | | | | | | | | | |
| | particles (D) | (D3) | | | parts by mass | | | | | | | | | |
| | Aqueous medium | Ion-exchanged | | | parts by mass | 129.1 | 129.1 | 129.1 | 129.1 | 129.1 | 154.1 | 104.1 | 129.1 | 129.1 |
| | | water | | | | | | | | | | | | |
| Production | Name of aqueous silicone resin emulsion | | | | | (S-1) | (S-2) | (S-3) | (S-4) | (S-5) | (S-6) | (S-7) | (S-8) | (S-9) |
| of aqueous | Organic solvent | Distill off | Amount of (B1) | −(B1) | parts by mass | −91.6 | −84.2 | −65.5 | −91.6 | −91.6 | −91.6 | −91.6 | −91.6 | −91.6 |
| silicone | replacement | solvent | distilled off | | | | | | | | | | | |
| resin | step | | (amount of | | | | | | | | | | | |
| emulsion | | | desolventation) | | | | | | | | | | | |
| | | Add solvent | Amount of (B) | (B2) | parts by mass | 29.7 | 29.7 | 29.7 | 29.7 | 29.7 | 13.3 | 46.0 | 39.4 | 34.4 |
| | | (solvent | added | (B3) | parts by mass | 14.0 | 14.0 | 14.0 | 14.0 | 14.0 | 7.0 | 21.0 | 4.2 | 9.4 |
| | | replacement) | | | | | | | | | | | | |
| | After organic | Mass ratio | (A):(B) | | | 1:0.47 | 1:0.47 | 1:0.47 | 1:0.47 | 1:0.47 | 1:0.22 | 1:0.72 | 1:0.47 | 1:0.47 |
| | solvent | in silicone | (B2):(B3) | | | 1:0.47 | 1:0.47 | 1:0.47 | 1:0.47 | 1:0.47 | 1:0.53 | 1:0.46 | 1:0.11 | 1:0.27 |
| | replacement | resin-organic | | | | | | | | | | | | |
| | step | solvent mixture | | | | | | | | | | | | |
| | Mixing step | Add solvent | Amount of (B) | (B2) | parts by mass | 3.0 | 3.0 | 3.0 | 3.0 | 3.0 | 3.0 | 3.0 | 3.0 | 3.0 |
| | | | added | (B3) | parts by mass | — | — | — | — | — | — | — | — | — |

| | | | | | | | | | | | | |
|---|---|---|---|---|---|---|---|---|---|---|---|---|
| | Content and mass | Total content of (B2) | parts by mass | 32.7 | 32.7 | 32.7 | 32.7 | 32.7 | 16.4 | 49.1 | 42.5 | 37.4 |
| | ratio in silicone | Total content of (B3) | parts by mass | 14.0 | 14.0 | 14.0 | 14.0 | 14.0 | 7.0 | 21.0 | 4.2 | 9.4 |
| After mixing | resin mixture | (A1):(A2) | | 98:2 | 90:10 | 70:30 | 99:1 | 30:70 | 98:2 | 98:2 | 98:2 | 98:2 |
| step | | (A):(B) | | 1:0.5 | 1:0.5 | 1:0.5 | 1:0.5 | 1:0.5 | 1:0.25 | 1:0.75 | 1:0.5 | 1:0.5 |
| | | (B2):(B3) | | 1:0.43 | 1:0.43 | 1:0.43 | 1:0.43 | 1:0.43 | 1:0.43 | 1:0.43 | 1:0.1 | 1:0.25 |
| | | Content of (D) based on 100 parts | parts by mass | 6.0 | 6.0 | 6.0 | 6.0 | 6.0 | 6.0 | 6.0 | 6.0 | 6.0 |
| | | by mass of (A) | | | | | | | | | | |
| | Add and mix | Amount of (C) added | parts by mass | 7.9 | 7.9 | 7.9 | 7.9 | 7.9 | 7.9 | 7.9 | 7.9 | 7.9 |
| Emulsification | (emulsify) (C) | Amount of ion-exchanged water added | parts by mass | 129.1 | 129.1 | 129.1 | 129.1 | 129.1 | 154.1 | 104.1 | 129.1 | 129.1 |
| step | and ion- | Total amount of (C) and ion-exchanged | parts by mass | 137.0 | 137.0 | 137.0 | 137.0 | 137.0 | 162.0 | 112.0 | 137.0 | 137.0 |
| | exchanged | water added | | | | | | | | | | |
| | water | Particle diameter of aqueous | nm | 250 | 250 | 250 | 250 | 250 | 250 | 250 | 300 | 280 |
| | | silicone resin emulsion | | | | | | | | | | |
| Post-mixing | Post-mix (D) | Content of (D) based on 100 parts | parts by mass | — | — | — | — | — | — | — | — | — |
| step | | by mass of (A) | | | | | | | | | | |
| | | Total content of (B2) after post-mixing | parts by mass | — | — | — | — | — | — | — | — | — |
| | | step | | | | | | | | | | |

| | | | | | | | | | | |
|---|---|---|---|---|---|---|---|---|---|---|
| Evaluation | Dispersibility of aqueous silicone resin emulsion | ∘ | ∘ | ∘ | ∘ | ∘ | ∘ | ∘ | ∘Δ | ∘ |
| results | Storage stability of aqueous silicone resin emulsion | ∘ | ∘ | ∘ | ∘ | ∘ | ∘ | ∘ | ∘ | ∘ |
| | Clear coating film appearance | ∘ | ∘ | ∘ | ∘ | ∘ | ∘ | ∘ | ∘ | ∘ |
| | Ultraviolet transmittance (%) of clear coating film | 5 | 5 | 5 | 5 | 5 | 5 | 5 | 5 | 5 |
| | Acid resistance | ∘ | ∘ | ∘ | ∘ | ∘ | ∘ | ∘ | ∘ | ∘ |
| | Weatherability | ∘ | ∘ | ∘ | ∘ | ∘ | ∘ | ∘ | ∘ | ∘ |

TABLE 3

| | | | | | | Examples | | | | | | | | |
|---|---|---|---|---|---|---|---|---|---|---|---|---|---|---|
| | | | | | | 10 | 11 | 12 | 13 | 14 | 15 | 16 | 17 | 18 |
| Aqueous | Silicone | (A1-1) | | | parts by mass | 91.6 | 91.6 | 91.6 | 93.5 | | | 91.6 | 91.6 | 91.6 |
| silicone | resin | (A1-2) | | | parts by mass | | | | | 91.6 | | | | |
| resin | (A) | (A1-3) | | | parts by mass | | | | | | 91.6 | | | |
| emulsion | | (A2-1) | | | parts by mass | 1.9 | 1.9 | 1.9 | 0.0 | 1.9 | 1.9 | | 1.9 | 1.9 |
| | | (A2-2) | | | parts by mass | | | | | | | 1.9 | | |
| | Organic | (B1-1) | | | parts by mass | 91.6 | 91.6 | 91.6 | 93.6 | | 61.1 | 91.6 | 91.6 | 91.6 |
| | solvent | (B1-2) | | | parts by mass | | | | | 137.4 | | | | |
| | (B) | (B2-1) | | | parts by mass | 16.3 | 32.7 | 32.7 | 32.7 | 32.7 | 32.7 | 32.7 | | |
| | | (B2-2) | | | parts by mass | | | | | | | | 32.7 | 32.7 |
| | | (B3-1) | | | parts by mass | 30.4 | 14.0 | 14.0 | 14.0 | 14.0 | 14.0 | 14.0 | | 14.0 |
| | | (B3-2) | | | parts by mass | | | | | | | | 14.0 | |
| | Emulsifier | (C1) | | | parts by mass | 6.1 | 6.1 | 6.1 | 6.1 | 6.1 | 6.1 | 6.1 | 6.1 | 6.1 |
| | (C) | (C2) | | | parts by mass | 1.9 | 1.9 | 1.9 | 1.9 | 1.9 | 1.9 | 1.9 | 1.9 | 1.9 |
| | | (C3) | | | parts by mass | | | | | | | | | |
| | Inorganic | (D1) | | | parts by mass | 5.6 | 2.8 | 11.2 | 5.6 | 5.6 | 5.6 | 5.6 | 5.6 | 5.6 |
| | oxide fine | (D2) | | | parts by mass | | | | | | | | | |
| | particles (D) | (D3) | | | parts by mass | | | | | | | | | |
| | Aqueous medium | Ion-exchanged | | | parts by mass | 129.1 | 129.1 | 129.1 | 129.1 | 129.1 | 129.1 | 129.1 | 129.1 | 129.1 |
| | | water | | | | | | | | | | | | |
| Production | Name of aqueous silicone resin emulsion | | | | | (S-10) | (S-11) | (S-12) | (S-13) | (S-14) | (S-15) | (S-16) | (S-17) | (S-18) |
| of aqueous | Organic solvent | Distill off | Amount of (B1) | −(B1) | parts by mass | −91.6 | −91.6 | −91.6 | −91.6 | −137.4 | −61.1 | −91.6 | −91.6 | −91.6 |
| silicone | replacement | solvent | distilled off | | | | | | | | | | | |
| resin | step | | (amount of | | | | | | | | | | | |
| emulsion | | | desolventation) | | | | | | | | | | | |
| | | Add solvent | Amount of (B) | (B2) | parts by mass | 13.3 | 31.2 | 26.7 | 29.7 | 29.7 | 29.7 | 29.7 | 29.7 | 29.7 |
| | | (solvent | added | (B3) | parts by mass | 30.4 | 14.0 | 14.0 | 14.0 | 14.0 | 14.0 | 14.0 | 14.0 | 14.0 |
| | | replacement) | | | | | | | | | | | | |
| | After organic | Mass ratio | (A):(B) | | | 1:0.47 | 1:0.48 | 1:0.44 | 1:0.47 | 1:0.47 | 1:0.47 | 1:0.48 | 1:0.47 | 1:0.47 |
| | solvent | in silicone | (B2):(B3) | | | 1:2.28 | 1:0.45 | 1:0.53 | 1:0.47 | 1:0.47 | 1:0.47 | 1:0.47 | 1:0.47 | 1:0.47 |
| | replacement | resin-organic | | | | | | | | | | | | |
| | step | solvent mixture | | | | | | | | | | | | |
| | Mixing step | Add solvent | Amount of (B) | (B2) | parts by mass | 3.0 | 1.5 | 6.0 | 3.0 | 3.0 | 3.0 | 3.0 | 3.0 | 3.0 |
| | | | added | (B3) | parts by mass | — | — | — | — | — | — | — | — | — |

| | | | | | | | | | | | | |
|---|---|---|---|---|---|---|---|---|---|---|---|---|
| | Content and mass | Total content of (B2) | parts by mass | 16.3 | 32.7 | 32.7 | 32.7 | 32.7 | 32.7 | 32.7 | 32.7 | 32.7 |
| | ratio in silicone | Total content of (B3) | parts by mass | 30.4 | 14.0 | 14.0 | 14.0 | 14.0 | 14.0 | 14.0 | 14.0 | 14.0 |
| After mixing | resin mixture | (A1):(A2) | | 98:2 | 98:2 | 98:2 | 100:0 | 98:2 | 98:2 | 98:2 | 98:2 | 98:2 |
| step | | (A):(B) | | 1:0.5 | 1:0.5 | 1:0.5 | 1:0.5 | 1:0.5 | 1:0.5 | 1:0.5 | 1:0.5 | 1:0.5 |
| | | (B2):(B3) | | 1:1.86 | 1:0.43 | 1:0.43 | 1:0.43 | 1:0.43 | 1:0.43 | 1:0.43 | 1:0.43 | 1:0.43 |
| | | Content of (D) based on 100 parts | parts by mass | 6.0 | 3.0 | 12.0 | 6.0 | 6.0 | 6.0 | 6.0 | 6.0 | 6.0 |
| | | by mass of (A) | | | | | | | | | | |
| | Add and mix | Amount of (C) added | parts by mass | 7.9 | 7.9 | 7.9 | 7.9 | 7.9 | 7.9 | 7.9 | 7.9 | 7.9 |
| Emulsification | (emulsify) (C) | Amount of ion-exchanged water added | parts by mass | 129.1 | 129.1 | 129.1 | 129.1 | 129.1 | 129.1 | 129.1 | 129.1 | 129.1 |
| step | and ion- | Total amount of (C) and ion-exchanged | parts by mass | 137.0 | 137.0 | 137.0 | 137.0 | 137.0 | 137.0 | 137.0 | 137.0 | 137.0 |
| | exchanged | water added | | | | | | | | | | |
| | water | Particle diameter of aqueous | nm | 280 | 250 | 250 | 250 | 250 | 250 | 250 | 250 | 250 |
| | | silicone resin emulsion | | | | | | | | | | |
| Post-mixing | Post-mix (D) | Content of (D) based on 100 parts | parts by mass | — | — | — | — | — | — | — | — | — |
| step | | by mass of (A) | | | | | | | | | | |
| | | Total content of (B2) after post-mixing | parts by mass | — | — | — | — | — | — | — | — | — |
| | | step | | | | | | | | | | |

| | | | | | | | | | | |
|---|---|---|---|---|---|---|---|---|---|---|
| Evaluation | Dispersibility of aqueous silicone resin emulsion | ∘ | ∘ | ∘ | ∘ | ∘ | ∘ | ∘ | ∘ | ∘ |
| results | Storage stability of aqueous silicone resin emulsion | ∘ | ∘ | ∘ | ∘ | ∘ | ∘ | ∘ | ∘ | ∘ |
| | Clear coating film appearance | ∘ | ∘ | ∘ | ∘ | ∘ | ∘ | ∘ | ∘ | ∘ |
| | Ultraviolet transmittance (%) of clear coating film | 5 | 10 | 3 | 5 | 5 | 5 | 5 | 5 | 5 |
| | Acid resistance | ∘ | ∘ | ∘ | ∘ | ∘ | ∘ | ∘ | ∘ | ∘ |
| | Weatherability | ∘ | ∘ | ∘ | ∘ | ∘ | ∘ | ∘ | ∘ | ∘ |

TABLE 4

| | | | | | | Examples | | | | | | | | |
|---|---|---|---|---|---|---|---|---|---|---|---|---|---|---|
| | | | | | | 19 | 20 | 21 | 22 | 23 | 24 | 25 | 26 | 27 |
| Aqueous | Silicone | (A1-1) | | | parts by mass | 91.6 | 91.6 | 91.6 | 91.6 | 91.6 | 91.6 | 74.8 | 46.8 | 91.6 |
| silicone | resin | (A1-2) | | | parts by mass | | | | | | | | | |
| resin | (A) | (A1-3) | | | parts by mass | | | | | | | | | |
| emulsion | | (A2-1) | | | parts by mass | 1.9 | 1.9 | 1.9 | 1.9 | 1.9 | 1.9 | 18.7 | 46.8 | 1.9 |
| | | (A2-2) | | | parts by mass | | | | | | | | | |
| | Organic | (B1-1) | | | parts by mass | 91.6 | 91.6 | 91.6 | 91.6 | 91.6 | 91.6 | 74.8 | 46.8 | 91.6 |
| | solvent | (B1-2) | | | parts by mass | | | | | | | | | |
| | (B) | (B2-1) | | | parts by mass | 32.7 | 32.7 | 32.7 | 32.7 | 32.7 | 32.7 | 32.7 | 32.7 | 8.2 |
| | | (B2-2) | | | parts by mass | | | | | | | | | |
| | | (B3-1) | | | parts by mass | | 14.0 | 14.0 | 14.0 | 14.0 | 14.0 | 14.0 | 14.0 | 3.5 |
| | | (B3-2) | | | parts by mass | 14.0 | | | | | | | | |
| | Emulsifier | (C1) | | | parts by mass | 6.1 | | 6.1 | 6.1 | 6.1 | 6.1 | 6.1 | 6.1 | 6.1 |
| | (C) | (C2) | | | parts by mass | 1.9 | 7.9 | | 3.7 | 1.9 | 1.9 | 1.9 | 1.9 | 1.9 |
| | | (C3) | | | parts by mass | | | 1.9 | | | | | | |
| | Inorganic | (D1) | | | parts by mass | 5.6 | 5.6 | 5.6 | 5.6 | | | 5.6 | 5.6 | 5.6 |
| | oxide fine | (D2) | | | parte by mass | | | | | 5.6 | | | | |
| | particles (D) | (D3) | | | parts by mass | | | | | | 5.6 | | | |
| | Aqueous medium | Ion-exchanged | | | parts by mass | 129.1 | 129.1 | 129.1 | 129.1 | 129.1 | 129.1 | 129.1 | 129.1 | 165.8 |
| | | water | | | | | | | | | | | | |
| Production | Name of aqueous silicone resin emulsion | | | | | (S-19) | (S-20) | (S-21) | (S-22) | (S-23) | (S-24) | (S-25) | (S-26) | (S-27) |
| of aqueous | Organic solvent | Distill off | Amount of (B1) | −(B1) | parts by mass | −91.6 | −91.6 | −91.6 | −91.6 | −91.6 | −91.6 | −74.8 | −46.8 | −91.6 |
| silicone | replacement | solvent | distilled off | | | | | | | | | | | |
| resin | step | | (amount of | | | | | | | | | | | |
| emulsion | | | desolventation) | | | | | | | | | | | |
| | | Add solvent | Amount of (B) | (B2) | parts by mass | 29.7 | 29.7 | 29.7 | 29.7 | 29.7 | 29.7 | 29.7 | 29.7 | 5.2 |
| | | (solvent | added | (B3) | parts by mass | 14.0 | 14.0 | 14.0 | 14.0 | 14.0 | 14.0 | 14.0 | 14.0 | 3.5 |
| | | replacement) | | | | | | | | | | | | |
| | After organic | Mass ratio | (A):(B) | | | 1:0.47 | 1:0.47 | 1:0.47 | 1:0.47 | 1:0.47 | 1:0.47 | 1:0.47 | 1:0.47 | 1:0.09 |
| | solvent | in silicone | (B2):(B3) | | | 1:0.47 | 1:0.47 | 1:0.47 | 1:0.47 | 1:0.47 | 1:0.47 | 1:0.47 | 1:0.47 | 1:0.68 |
| | replacement | resin-organic | | | | | | | | | | | | |
| | step | solvent mixture | | | | | | | | | | | | |
| | Mixing step | Add solvent | Amount of (B) | (B2) | parts by mass | 3.0 | 3.0 | 3.0 | 3.0 | 3.0 | 3.0 | 3.0 | 3.0 | 3.0 |
| | | | added | (B3) | parts by mass | — | — | — | — | — | — | — | — | — |

| | | | | | | | | | | | | |
|---|---|---|---|---|---|---|---|---|---|---|---|---|
| | Content and mass | Total content of (B2) | parts by mass | 32.7 | 32.7 | 32.7 | 32.7 | 32.7 | 32.7 | 32.7 | 32.7 | 8.2 |
| | ratio in silicone | Total content of (B3) | parts by mass | 14.0 | 14.0 | 14.0 | 14.0 | 14.0 | 14.0 | 14.0 | 14.0 | 3.5 |
| After mixing | resin mixture | (A1):(A2) | | 98:2 | 98:2 | 98:2 | 98:2 | 98:2 | 98:2 | 70:30 | 50:50 | 98:2 |
| step | | (A):(B) | | 1:0.5 | 1:0.5 | 1:0.5 | 1:0.5 | 1:0.5 | 1:0.5 | 1:0.5 | 1:0.5 | 1:0.13 |
| | | (B2):(B3) | | 1:0.43 | 1:0.43 | 1:0.43 | 1:0.43 | 1:0.43 | 1:0.43 | 1:0.43 | 1:0.43 | 1:0.43 |
| | | Content of (D) based on 100 parts | parts by mass | 6.0 | 6.0 | 6.0 | 6.0 | 6.0 | 6.0 | 6.0 | 6.0 | 6.0 |
| | | by mass of (A) | | | | | | | | | | |
| | Add and mix | Amount of (C) added | parts by mass | 7.9 | 7.9 | 7.9 | 9.8 | 7.9 | 7.9 | 7.9 | 7.9 | 7.9 |
| Emulsification | (emulsify) (C) | Amount of ion-exchanged water added | parts by mass | 129.1 | 129.1 | 129.1 | 129.1 | 129.1 | 129.1 | 129.1 | 129.1 | 165.8 |
| step | and ion- | Total amount of (C) and ion-exchanged | parts by mass | 137.0 | 137.0 | 137.0 | 138.9 | 137.0 | 137.0 | 137.0 | 137.0 | 173.7 |
| | exchanged | water added | | | | | | | | | | |
| | water | Particle diameter of aqueous | nm | 250 | 250 | 250 | 250 | 250 | 250 | 250 | 250 | 300 |
| | | silicone resin emulsion | | | | | | | | | | |
| Post-mixing | Post-mix (D) | Content of (D) based on 100 parts | parts by mass | — | — | — | — | — | — | — | — | — |
| step | | by mass of (A) | | | | | | | | | | |
| | | Total content of (B2) after post-mixing | parts by mass | — | — | — | — | — | — | — | — | — |
| | | step | | | | | | | | | | |

| | | | | | | | | | | |
|---|---|---|---|---|---|---|---|---|---|---|
| Evaluation | Dispersibility of aqueous silicone resin emulsion | ∘ | ∘ | ∘ | ∘ | ∘ | ∘ | ∘ | ∘ | ∘Δ |
| results | Storage stability of aqueous silicone resin emulsion | ∘ | ∘ | ∘ | ∘ | ∘ | ∘ | ∘ | ∘ | ∘ |
| | Clear coating film appearance | ∘ | ∘ | ∘ | ∘ | ∘ | ∘ | ∘ | ∘ | ∘ |
| | Ultraviolet transmittance (%) of clear coating film | 5 | 5 | 5 | 5 | 5 | 5 | 5 | 5 | 5 |
| | Acid resistance | ∘ | ∘ | ∘ | ∘ | ∘ | ∘ | ∘ | ∘ | ∘ |
| | Weatherability | ∘ | ∘ | ∘ | ∘ | ∘ | ∘ | ∘ | ∘ | ∘ |

TABLE 5

| | | | | | | Examples | | | | | | |
|---|---|---|---|---|---|---|---|---|---|---|---|---|
| | | | | | | 28 | 29 | 30 | 31 | 32 | 33 | 34 |
| Aqueous | Silicone | (A1-1) | | | parts by mass | 91.6 | 91.6 | 91.6 | 91.6 | 91.6 | Mixture of | Mixture of |
| silicone | resin | (A1-2) | | | parts by mass | | | | | | (S-12) and | (S-13) and |
| resin | (A) | (A1-3) | | | parts by mass | | | | | | (s-8) | (s-9) |
| emulsion | | (A2-1) | | | parts by mass | 1.9 | 1.9 | 1.9 | 1.9 | 1.9 | | |
| | | (A2-2) | | | parts by mass | | | | | | | |
| | Organic | (B1-1) | | | parts by mass | 91.6 | 91.6 | 91.6 | 91.6 | 91.6 | | |
| | solvent | (B1-2) | | | parts by mass | | | | | | | |
| | (B) | (B2-1) | | | parts by mass | 98.1 | 32.7 | 32.7 | 32.7 | 32.7 | | |
| | | (B2-2) | | | parts by mass | | | | | | | |
| | | (B3-1) | | | parts by mass | 42.0 | 14.0 | 14.0 | 14.0 | 14.0 | | |
| | | (B3-2) | | | parts by mass | | | | | | | |
| | Emulsifier | (C1) | | | parts by mass | 6.1 | 6.1 | 6.1 | 6.1 | 6.1 | | |
| | (C) | (C2) | | | parts by mass | 1.9 | 1.9 | 1.9 | 1.9 | 1.9 | | |
| | | (C3) | | | parts by mass | | | | | | | |
| | Inorganic | (D1) | | | parts by mass | 5.6 | 5.6 | 5.6 | 5.6 | 5.6 | | |
| | oxide fine | (D2) | | | parts by mass | | | | | | | |
| | particles (D) | (D3) | | | parts by mass | | | | | | | |
| | Aqueous medium | Ion-exchanged | | | parts by mass | 82.4 | 129.1 | 129.1 | 129.1 | 129.1 | | |
| | | water | | | | | | | | | | |
| Production | Name of aqueous silicone resin emulsion | | | | | (S-28) | (S-29) | (S-30) | (S-31) | (S-32) | (S-33) | (S-34) |
| of aqueous | Organic solvent | Distill off | Amount of (B1) | −(B1) | parts by mass | −91.6 | −91.6 | −91.6 | −91.6 | −91.6 | | |
| silicone | replacement | solvent | distilled off | | | | | | | | | |
| resin | step | | (amount of | | | | | | | | | |
| emulsion | | | desolventation) | | | | | | | | | |
| | | Add solvent | Amount of (B) | (B2) | parts by mass | 95.1 | — | 29.7 | 16.1 | 29.7 | | |
| | | (solvent | added | (B3) | parts by mass | 42.0 | 14.0 | — | 7.0 | 14.0 | | |
| | | replacement) | | | | | | | | | | |
| | After organic | Mass ratio | (A):(B) | | | 1:1.47 | 1:0.15 | 1:0.32 | 1:0.25 | 1:0.47 | | |
| | solvent | in silicone | (B2):(B3) | | | 1:0.44 | 0:1 | 1:0 | 1:0.43 | 1:0.47 | | |
| | replacement | resin-organic | | | | | | | | | | |
| | step | solvent mixture | | | | | | | | | | |
| | Mixing step | Add solvent | Amount of (B) | (B2) | parts by mass | 3.0 | 32.7 | 3.0 | 16.6 | 3.0 | | |
| | | | added | (B3) | parts by mass | — | — | 14.0 | 7.0 | — | | |

| | | | | | | | | | | |
|---|---|---|---|---|---|---|---|---|---|---|
| | Content and mass | Total content of (B2) | parts by mass | 98.1 | 32.7 | 32.7 | 32.7 | 32.7 | | |
| | ratio in silicone | Total content of (B3) | parts by mass | 42.0 | 14.0 | 14.0 | 14.0 | 14.0 | | |
| After mixing | resin mixture | (A1):(A2) | | 98:2 | 98:2 | 98:2 | 98:2 | 98:2 | 98:2 | 98:2 |
| step | | (A):(B) | | 1:1.5 | 1:0.5 | 1:0.5 | 1:0.5 | 1:0.5 | 1:0.5 | 1:0.5 |
| | | (B2):(B3) | | 1:0.43 | 1:0.43 | 1:0.43 | 1:0.43 | 1:0.43 | 1:0.43 | 1:0.43 |
| | | Content of (D) based on 100 parts by mass of (A | parts by mass | 6.0 | 6.0 | 6.0 | 6.0 | 6.0 | 6.0 | 5.9 |
| | Add and mix | Amount of (C) added | parts by mass | 7.9 | 7.9 | 7.9 | 7.9 | 7.9 | | |
| Emulsification | (emulsify) (C) | Amount of ion-exchanged water added | parts by mass | 82.4 | 129.1 | 129.1 | 129.1 | 129.1 | | |
| step | and ion-exchanged | Total amount of (C) and ion-exchanged water added | parts by mass | 90.3 | 137.0 | 137.0 | 137.0 | 137.0 | | |
| | water | Particle diameter of aqueous silicone resin emulsion | nm | 300 | 250 | 250 | 250 | 250 | 250 | 250 |
| Post-mixing | Post-mix (D) | Content of (D) based on 100 parts by mass of (A) | parts by mass | | | | | | | |
| step | | Total content of (B2) after post-mixing | parts by mass | | | | | | | |

| | | | | | | | | |
|---|---|---|---|---|---|---|---|---|
| Evaluation | Dispersibility of aqueous silicone resin emulsion step | ∘Δ | ∘ | ∘ | ∘ | ∘ | ∘ | ∘ |
| results | Storage stability of aqueous silicone resin emulsion | ∘ | ∘ | ∘ | ∘ | ∘ | ∘ | ∘ |
| | Clear coating film appearance | ∘ | ∘ | ∘ | ∘ | ∘ | ∘ | ∘ |
| | Ultraviolet transmittance (%) of clear coating film | 5 | 5 | 5 | 5 | 5 | 3 | 5 |
| | Acid resistance | ∘ | ∘ | ∘ | ∘ | ∘ | ∘ | ∘ |
| | Weatherability | ∘ | ∘ | ∘ | ∘ | ∘ | ∘ | ∘ |

TABLE 6

| | | | | | | Comparative Examples | | | | | | | | |
|---|---|---|---|---|---|---|---|---|---|---|---|---|---|---|
| | | | | | | 1 | 2 | 3 | 4 | 5 | 6 | 7 | 8 | 9 |
| Aqueous | Silicone | (A1-1) | | | parts by mass | 91.6 | | 91.6 | 91.6 | 91.6 | 91.6 | 91.6 | 91.6 | |
| silicone | resin | (A1-2) | | | parts by mass | | | | | | | | | |
| resin | (A) | (A1-3) | | | parts by mass | | | | | | | | | |
| emulsion | | (A2-1) | | | parts by mass | 1.9 | 93.5 | 1.9 | 1.9 | 1.9 | 1.9 | 1.9 | 1.9 | 93.5 |
| | | (A2-2) | | | parts by mass | | | | | | | | | |
| | Organic | (B1-1) | | | parts by mass | 91.6 | | 91.6 | 91.6 | 91.6 | 91.6 | 91.6 | 91.6 | |
| | solvent | (B1-2) | | | parts by mass | | | | | | | | | |
| | (B) | (B2-1) | | | parts by mass | 32.7 | 32.7 | 32.7 | | 46.7 | 3.0 | 3.0 | 32.7 | 32.7 |
| | | (B2-2) | | | parts by mass | | | | | | | | | |
| | | (B3-1) | | | parts by mass | 14.0 | 14.0 | 14.0 | 46.7 | | | | 14.0 | 14.0 |
| | | (B3-2) | | | parts by mass | | | | | | | | | |
| | Emulsifier | (C1) | | | parts by mass | 6.1 | 6.1 | 6.1 | 6.1 | 6.1 | 6.1 | 6.1 | 6.1 | 6.1 |
| | (C) | (C2) | | | parts by mass | 1.9 | 1.9 | 1.9 | 1.9 | 1.9 | 1.9 | 1.9 | 1.9 | 1.9 |
| | | (C3) | | | parts by mass | | | | | | | | | |
| | Inorganic | (D1) | | | parts by mass | 5.6 | 5.6 | 5.6 | 5.6 | 5.6 | 5.6 | 5.6 | | |
| | oxide fine | (D2) | | | parts by mass | | | | | | | | | |
| | particles (D) | (D3) | | | parts by mass | | | | | | | | | |
| | Aqueous medium | Ion-exchanged water | | | parts by mass | 129.1 | 129.1 | 37.5 | 129.1 | 129.1 | 175.9 | 84.2 | 129.1 | 129.1 |
| Production | Name of aqueous silicone resin emulsion | | | | | (s-1) | (s-2) | (s-3) | (s-4) | (s-5) | (s-6) | (s-7) | (s-8) | (s-9) |
| of aqueous | Organic solvent | Distill off | Amount of (B1) | −(B1) | parts by mass | −91.6 | — | — | −91.6 | −91.6 | −91.6 | — | −91.6 | — |
| silicone | replacement | solvent | distilled off | | | | | | | | | | | |
| resin | step | | (amount of | | | | | | | | | | | |
| emulsion | | | desolventation) | | | | | | | | | | | |
| | | Add solvent | Amount of (B) | (B2) | parts by mass | 32.7 | 29.7 | 29.7 | — | 43.7 | — | — | 32.7 | 32.7 |
| | | (solvent | added | (B3) | parts by mass | 14.0 | 14.0 | 14.0 | 43.7 | — | — | — | 14.0 | 14.0 |
| | | replacement) | | | | | | | | | | | | |
| | After organic | Mass ratio | (A):(B) | | | 1:0.50 | 1:0.47 | 1:0.47 | 1:0.47 | 1:0.47 | 1:0 | 1:0 | 1:0.5 | 1:0.5 |
| | solvent | in silicone | (B2):(B3) | | | 1:0.43 | 1:0.47 | 1:0.47 | 0:1 | 1:0 | — | — | 1:0.43 | 1:0.43 |
| | replacement | resin-organic | | | | | | | | | | | | |
| | step | solvent mixture | | | | | | | | | | | | |
| | Mixing step | Add solvent | Amount of (B) | (B2) | parts by mass | — | 3.0 | 3.0 | — | 3.0 | 3.0 | 3.0 | — | — |
| | | | added | (B3) | parts by mass | — | — | — | 3.0 | — | — | — | — | — |

| | | | | | | | | | | | | |
|---|---|---|---|---|---|---|---|---|---|---|---|---|
| | Content and mass | Total content of (B2) | parts by mass | 32.7 | 32.7 | 32.7 | — | 46.7 | 3.0 | 3.0 | 32.7 | 32.7 |
| | ratio in silicone | Total content of (B3) | parts by mass | 14.0 | 14.0 | 14.0 | 46.7 | — | — | — | 14.0 | 14.0 |
| After mixing | resin mixture | (A1):(A2) | | 98:2 | 0:100 | 98:2 | 98:2 | 98:2 | 98:2 | 98:2 | 98:2 | 0:100 |
| step | | (A):(B) | | 1:0.47 | 1:0.47 | 1:0.47 | 1:0.47 | 1:0.47 | 1:0 | 1:0 | 1:0.5 | 1:0.5 |
| | | (B2):(B3) | | 1:0.46 | 1:0.46 | 1:0.46 | 0:1 | 1:0 | — | — | 1:0.43 | 1:0.43 |
| | | Content of (D) based on 100 parts by mass of (A) | parts by mass | 0.0 | 6.0 | 6.0 | 6.0 | 6.0 | 6.0 | 6.0 | 0.0 | 0.0 |
| | Add and mix | Amount of (C) added | parts by mass | 7.9 | 7.9 | 7.9 | 7.9 | 7.9 | 7.9 | 7.9 | 7.9 | 7.9 |
| Emulsification | (emulsify) (C) | Amount of ion-exchanged water added | parts by mass | 129.1 | 129.1 | 37.5 | 129.1 | 129.1 | 175.9 | 84.2 | 129.1 | 129.1 |
| step | and ion-exchanged | Total amount of (C) and ion-exchanged water added | parts by mass | 137.0 | 137.0 | 45.4 | 137.0 | 137.0 | 183.8 | 137.0 | 137.0 | 137.0 |
| | water | Particle diameter of aqueous silicone resin emulsion | nm | 220 | — | — | — | — | — | — | 220 | 220 |
| Post-mixing | Post-mix (D) | Content of (D) based on 100 parts by mass of (A) | parts by mass | 6 | — | — | — | — | — | — | — | — |
| step | | Total content of (B2) after post-mixing step | parts by mass | 32.7 | — | — | — | — | — | — | — | — |

| | | | | | | | | | | |
|---|---|---|---|---|---|---|---|---|---|---|
| Evaluation | Dispersibility of aqueous silicone resin emulsion | ∘ | x | x | x | x | x | x | ∘ | ∘ |
| results | Storage stability of aqueous silicone resin emulsion | ∘ | — | — | — | — | — | — | ∘ | ∘ |
| | Clear coating film appearance | ∘ | — | — | — | — | — | — | ∘ | ∘ |
| | Ultraviolet transmittance (%) of clear coating film | 5 | — | — | — | — | — | — | 30 | 30 |
| | Acid resistance | x | — | — | — | — | — | — | ∘ | ∘ |
| | Weatherability | ∘ | — | — | — | — | — | — | x | x |

Examples 1 to 34 are examples of the present disclosure, in which it was possible to produce an aqueous clear coating composition comprising inorganic oxide fine particles as an inorganic ultraviolet absorber. The aqueous clear coating composition comprised an aqueous silicone resin emulsion having good storage stability, and it was capable of forming a coating film with superior weatherability and durability (especially acid resistance) and high transparency.

Comparative Example 1 is an example in which the silicone resin mixture was free of inorganic oxide fine particles in the emulsification step, and the resulting coating film was poor in durability (acid resistance).

Comparative Examples 2, 3, and 7 are examples having no organic solvent replacement step, and the dispersibility of the resulting aqueous silicone resin emulsion was poor.

Comparative Example 4 is an example in which no organic solvent (B2) was used, and the dispersibility of the obtained aqueous silicone resin emulsion was poor.

Comparative Example 5 is an example in which no organic solvent (B3) was used, and the dispersibility of the resulting aqueous silicone resin emulsion was poor.

Comparative Example 6 is an example in which neither the organic solvent (B2) nor (B3) was used, and the dispersibility of the resulting aqueous silicone resin emulsion was poor.

Comparative Examples 8 and 9 are examples in which no inorganic oxide fine particles (D) were used, and the resulting coating films were poor in weatherability and ultraviolet transmittance.

The method for producing an aqueous clear coating composition of the present disclosure provides an aqueous clear coating composition that contains an aqueous silicone resin emulsion with good storage stability and it is capable of forming a coating film with superior weatherability and durability (especially acid resistance) and high transparency.

1. A method for producing an aqueous clear coating composition comprising an aqueous silicone resin emulsion, the method comprising:
obtaining a silicone resin-organic solvent mixture from a mixture of a silicone resin (A) with an organic solvent (B1) by replacing at least portion of the organic solvent (B1) with an organic solvent (B2) and/or an organic solvent (B3),
mixing the silicone resin-organic solvent mixture, the organic solvent (B2) and/or the organic solvent (B3), and inorganic oxide fine particles (D) to obtain a silicone resin mixture, and
subjecting the silicone resin mixture and a mixture of an emulsifier (C) and an aqueous medium to a mechanical emulsification treatment, or subjecting a mixture of the silicone resin mixture and an emulsifier (C) and an aqueous medium to a mechanical emulsification treatment to obtain an aqueous silicone resin emulsion,
wherein the silicone resin (A) comprises a branched organopolysiloxane (A1) having a weight average molecular weight of 5,000 to 300,000,
wherein the organic solvent (B1) comprises a hydrocarbon-based solvent having a solubility of 1 g/100 g-H₂O or less in water,
wherein the organic solvent (B2) comprises at least one solvent selected from a group consisting of an alcohol, an alkylene glycol monoalkyl ether, and an alkylene glycol dialkyl ether, and the organic solvent (B2) has a solubility of less than 5 g/100 g-H₂O in water,
wherein the organic solvent (B3) is at least one solvent selected from a group consisting of an alcohol, an alkylene glycol monoalkyl ether, and an alkylene glycol dialkyl ether, and the organic solvent (B3) has a solubility of 5 g/100 g-H₂O or more in water, and
wherein the silicone resin mixture comprises both the organic solvent (B2) and the organic solvent (B3).

2. The production method according to claim 1, wherein the silicone resin (A) comprises a linear organopolysiloxane (A2) having a weight average molecular weight of 1,000 to 30,000.

3. The production method according to claim 1, further comprising mixing the aqueous silicone resin emulsion with a silicone resin emulsion comprising a linear organopolysiloxane (A2) having a weight average molecular weight of 1,000 to 30,000 prepared beforehand.

4. The production method according to claim 2, wherein a mass ratio (A1):(A2) of the branched organopolysiloxane (A1) to the linear organopolysiloxane (A2) is 98:2 to 40:60 in the aqueous clear coating composition.

5. The production method according to claim 1, wherein a mass ratio (A):(B) of the silicone resin (A) to the organic solvent (B) is 1:1 to 1:0.2 in the aqueous clear coating composition.

6. The production method according to claim 1, wherein a mass ratio (B2):(B3) of the organic solvent (B2) to the organic solvent (B3) is 1:0.2 to 1:2 in the aqueous clear coating composition.

7. The production method according to claim 1, wherein the emulsifier (C) comprises an anionic surfactant.

8. The production method according to claim 1, wherein a content of the inorganic oxide fine particles (D) is 3 to 20 parts by mass based on 100 parts by mass of a solid content of the silicone resin (A) in the aqueous clear coating composition.

9. The production method according to claim 1, wherein the inorganic oxide fine particles (D) comprise at least one selected from a group consisting of titanium oxide, zinc oxide and cerium oxide.

10. The production method according to claim 1, wherein the inorganic oxide fine particles (D) have an average particle diameter of 20 to 300 nm.
